(19) United States
(12) Patent Application Publication
(10) Pub. No.: US 2016/0260183 A1
(43) Pub. Date: Sep. 8, 2016

(54) HEURISTIC FLIGHT INQUIRY SYSTEM AND METHOD FOR PROVIDING SAME

(71) Applicant: CREWMATE. CO., LTD, Gangnam-gu, Seoul (KR)

(72) Inventors: Do Gyun KIM, Yangpyeong-gun (KR); Sung Bae KIM, Yongin-si (KR)

(21) Appl. No.: 15/028,705

(22) PCT Filed: Sep. 29, 2014
(86) PCT No.: PCT/KR2014/009089

§ 371 Date: Apr. 11, 2016

(30) Foreign Application Priority Data
Oct. 11, 2013 (KR) 10-2013-0121005
Feb. 13, 2014 (KR) 10-2014-0016727

(51) Int. Cl. G06Q 50/14; G06Q 30/06; G06Q 10/02

(52) U.S. Cl. CPC G06Q 50/14; G06Q 10/025; G06Q 30/0627; G06Q 30/0643; G06Q 30/0631

(57) ABSTRACT

A heuristic flight inquiry system and a method for providing the same are disclosed. A heuristic flight inquiry method, according to one embodiment of the present invention, is the method for providing the heuristic flight inquiry system to select a target flight for a predetermined market—the market indicates a pair of a city of departure and a city of destination—comprising the steps of: providing, by the heuristic flight inquiry system, a route map of airlines corresponding to the market—the route map is a set of routes from the city of departure to the city of destination allowed by the fares and regulations of the airlines, and any one route is configured with at least one segment—to a terminal of a user; providing, by the heuristic flight inquiry system, first flight information corresponding to a first selection segment—the first selection segment can be any one single segment or a set of a plurality of connected single segments—to the terminal on the basis of the route map; receiving, by the heuristic flight inquiry system, a selection of any one of the first flights as a first selected flight of the first selection segment on the basis of the information on the first flights; and determining, by the heuristic flight inquiry system, the first selected flight as a first determined flight to form the target flight and determining flights corresponding to the remaining segments of the first selection segment to form the target flight.

### TECHNICAL FIELD

The present invention relates to a heuristic flight inquiry system and method, and more particularly, to a system and method of providing a variety of flight reservation options (e.g. fares and other fare-specific information, such as fare rules, available flight schedules, and seating status information) to a user when the user attempts to inquire about and/or reserve airline tickets, such that the user can reserve user-customized airline tickets by heuristically determining an available option in each step considering his or her preferences and travel plans.

### BACKGROUND ART

Airline tickets have values that tend to vanish if not used. Thus, airlines incessantly study how to fill the seats of flights with customers by causing customers to pay relatively expensive fares, and are thus selling airline tickets based on very complex pricing structures. Because of such complex pricing structures, even if customers use seats of the same grade on the same flight while being provided with the same onboard services, prices that are higher by as much as five times may be paid for tickets depending on the means of reservation or purchase thereof. Thus, even personnel (e.g. an travel agent), whose job is to inquire about and/or reserve airline tickets for customers, require a fairly long period of training and work experience in order to understand the fare structures of airline tickets and to be able to efficiently reserve airline tickets.

In spite of such complex fare structures for airline tickets, web services allowing a user to reserve airline tickets by himself or herself have grown and are widely used. However, respective current web services do not reflect complex fare structures sufficiently to satisfy a variety of user preferences, without a substantial improvement in services based on simple round trips.

Flight inquiry (or reservation) web services of the related art are generally divided into two types:

One type may be a fare driven method, an example of which is illustrated in FIG. 1.

FIG. 1 is a view illustrating a fare driven flight inquiry (reservation) method of the related art.

Referring to FIG. 1, when basic conditions (e.g. a departure location, a destination, a departure date, and the like) are input (S10), a service system inquires about fares corresponding to the input conditions and provides a list of inquired fares to a user terminal (S11, S12).

When a user selects one item from the list of fares (S12), the service system displays whether or not only specific previously-selected flight schedules among flight schedules (bundles of flights traveling from the departure location to the destination), selectable according to rules, are reservable at the pertinent fares or displays information regarding available flights or seats to the user (S13). Then, when a flight and a seat corresponding to information about a fare selected by the user is reservable (S14), the user can select and reserve the flight and seat (S15).

Here, only select specific schedules are displayed instead of the entirety of schedules because tens of thousands of schedules for long-distance flights are possible for some airlines and it is inefficient and impossible in terms of cost and time to search for the entirety of schedules.

In addition, an approach improving on the fare driven method includes displaying, at once, fare-specific schedules and whether or not seats in the schedules are reservable after conditions have been input by the user. However, since this approach is based on the list of fares and displays the schedules available in the list of fares as well as whether or not the schedules are reservable at the fares, this approach may be essentially the same as the fare driven method.

The fare driven method can provide only very limited search results, which are problematic. For example, in the case of a long-distance airline ticket for a flight across a continent (e.g. an airline ticket traveling between Seoul and Rome), tens of airlines are generally selling tens of airline tickets having different fares, and the schedules available at those fares are tens of thousands in some cases. In addition, each fare has hundreds of different rules, all of which must be satisfied in order to apply the pertinent fares to the pertinent schedules. It is impossible to search for all of such cases and display searched cases to the user. Thus, only a list of limited fares, limited schedules, and limited rules are searched for, and only airline tickets for simple journeys can be sold.

Another type of flight inquiry (or reservation) method may be a schedule driven method, an example of which is illustrated in FIG. 2.

FIG. 2 is a view illustrating a schedule driven flight inquiry (reservation) method of the related art.

Referring to FIG. 2, when a user inputs basic conditions for a journey (S20), a service system may extract airline tickets satisfying the input conditions using a preset algorithm and display the extracted airline tickets according to schedules as well as whether or not the airline tickets are reservable (e.g. reservable flights, seats, fares, and the like) to the user (S21). The user examines whether or not the airline tickets are reservable (S22), and when there is a reservable flight, selects and reserves the pertinent airline ticket (S23). Here, the flight extraction algorithm extracts a limited number of airline tickets that are determined to be optimal by comprehensively considering fares and rules of a number of airlines, available schedules, and seating statuses of the airlines.

As described above, the schedule driven method provides optimal flights determined by the algorithm to customers without limitation, at least in the range of search. However, as an important consideration, there is no algorithm able to provide a correct solution.

This fact is specifically described in a related art document (http://www.demarcken.org/carl/papers/ITA-software-travel-complexity/ITA-software-travel-complexity.pdf), published in 2003. This related art document may be included as a reference in the present invention. In addition, some terms used in the specification are disclosed in the related art, and further descriptions thereof will be omitted in the specification.

As disclosed in the related art, it is known to be impossible to derive a most ideal (e.g. cheapest) airline ticket under given search conditions. (It has been proved to be a NP-hard or EXPSPACE-hard problem according to conditions.) This is because a significantly large number of parameters (e.g. stopovers, number of stopovers, airlines, fares, fare rules, fare components, priceable units (Pus), and the like) must be considered in search for airline tickets and possible results increase exponentially with increases in a single parameter to be considered. Thus, the schedule driven method of the related art is based on the algorithm of a corresponding service, and can only derive approximate results that can be searched for by the algorithm.

However, due to these characteristics, the schedule driven method of the related art has the following problems:

First, there must be a possibility that a better search result (e.g. a cheaper airline ticket, an airline ticket having fewer stopovers, or the like) may be present, and information provided to the user must be unreliable.

Second, this method displays the prices of airline tickets to which the lowest fares are applied by reflecting the seating status of each schedule without providing information about respective fares. Thus, even if there is a possibility of a cheaper travel when the date is changed or the destination city is changed to a nearby city, such information is not provided to the user.

In addition, this problem becomes worse when an airline ticket having a plurality of segments (e.g. a multi-segment airline ticket) is searched for. That is, in the case of a plurality of segments, parameters to be considered to search for an airline ticket satisfying given conditions increase, such that an amount of search time exponentially increases. Thus, the process must be executed by disregarding or simplifying some parameters, thereby unavoidably deriving an unsatisfactory search result compared to a one-way, short-distance, or simple round trip flight. That is, in the schedule driven method, the service system considers all parameters to derive the result according to and purely by the algorithm of the service system. The qualities of the results inevitably become significantly worse with increases in the parameters to be considered.

Consequently, according to the flight inquiry and/or reservation methods of the related art, it is inconvenient to inquire about and/or reserve an airline ticket that the user desires. Even if an airline ticket is reserved in spite of such inconvenience, there is a high possibility that a better search result may exist, which is problematic. This problem is exacerbated when an airline ticket has a plurality of segments that must be selected.

### DISCLOSURE

### Technical Problem

The technical spirit of the present invention provides a method and system for inquiring about and/or reserving an airline ticket, and more particularly, a method and system for heuristically inquiring about and/or reserving an airline ticket, such that the judgment of a user can be reflected.

Also provided is a heuristic method and system allowing the user to determine specific parameters to be considered in inquiry and/or reservation of airline tickets. This reduces parameters to be considered by the system, thereby exponentially reducing the amount of search time. Accordingly, better search results (e.g. cheaper airline tickets) may be provided to the user.

In addition, the technical spirit of the present invention provides a method and system allowing the user to select fares, rules, and schedules of airline tickets in person according to his or her preferences. The user can actively design a journey and inquire about and/or reserve optimal airline tickets consistent with his or her plan for the journey, instead of passively designing the journey by selecting from a given list of airline tickets.

### Technical Solution

In order to overcome the technical problem, an embodiment of the present invention provides a heuristic flight inquiry method of selecting a target flight for a market in which a departure city and a target city are paired. The heuristic flight inquiry method may include: providing, by a heuristic flight inquiry system, a route map of an airline corresponding to the market to a terminal of a user, wherein the route map is a set of routes from the destination city to the target city allowable by fares and rules of the airline, one of the routes including one or more segments; providing, by the heuristic flight inquiry system, information about first flights corresponding to a first selection segment based on the route map to the terminal, wherein the first selection segment includes a single segment or a set of a plurality of connected single segments; having, by the heuristic flight inquiry system, one of the first flights selected as a first selected flight for the first selection segment based on the information about the first flights; and determining, by the heuristic flight inquiry system, the first selected flight as a first determined flight of the target flight and determining a flight corresponding to a remaining segment of the first selection segment of the target flight.

The step of providing the information about the first flights corresponding to the first selection segment to the terminal includes may further provide information about related flights corresponding to related segments of the first selection segment to the terminal, wherein the related segments are defined as segments including the departure city or the destination city of the first selection segment or segments included in the route map and predetermined to correspond to the first selection segment by the heuristic flight inquiry system

The step of providing the information about the first flights corresponding to the first selection segment to the terminal may include: having, by the heuristic flight inquiry system, the first selection segment selected from the terminal; and providing information about the flights corresponding to the selected first selection segment to the terminal.

The step of providing the information about the first flights corresponding to the first selection segment to the terminal may include: determining, by the heuristic flight inquiry system, a recommended segment by predetermined way and determining the determined recommended segment as the first selection segment; or providing information about the recommended segment to the terminal and having the recommended segment selected as the first selection segment from the terminal.

The step of providing the information about the first flights corresponding to the first selection segment to the terminal may further include, when a segment of married segments operated by the airline information is included in the first selection segment, providing information about flights corresponding to the married segments to the terminal.

The step of providing the information about the first flights corresponding to the first selection segment to the terminal may include providing the terminal with information about base fares of reservable booking classes of first flights that depart within predetermined marginal dates with respect to a reference departure date of the first selection segment.

The step of having, by the heuristic flight inquiry system, one of the first flights selected as the first selected flight for the first selection segment based on the information about the first flights may include: in response to an inquiry request for the first selected flight, judging, by the heuristic flight inquiry system, a first application fare rule including a base fare and a rule to be applied to the target flight according to selection of the first selected flight; displaying the judged first application fare rule on the terminal; and having the first selected flight selected from the terminal based on the displayed first application fare rule.

The step of having, by the heuristic flight inquiry system, one of the first flights selected as the first selected flight for the first selection segment based on the information about the first flights may include: in response to an inquiry request for the first selected flight, judging, by the heuristic flight inquiry system, overall fare information corresponding to the target flight of a case in which the first selected flight is determined as a determined flight; displaying the judged overall fare information on the terminal; and having the first selected flight selected from the terminal based on the displayed overall fare information.

The step of determining the flight corresponding to the remaining segment of the first selection segment of the target flight may include: providing, by the heuristic flight inquiry system, information about second flights corresponding to a second selection segment of the remaining segment to the terminal; having, by the heuristic flight inquiry system, one of the second flights selected as a second selected flight for the second selection segment based on the information about the second flights; and determining, by the heuristic flight inquiry system, the second selected flight as a second determined flight of the target flight.

The step of having, by the heuristic flight inquiry system, one of the second flights selected as the second selected flight for the second selection segment based on the information about the second flights may include: in response to an inquiry request for the second selected flight, judging, by the heuristic flight inquiry system, a second application fare rule including a base fare and a rule to be applied to the target flight according to selection of the second selected flight; displaying the judged second application fare rule on the terminal; and having the second selected flight selected based on the displayed second application fare rule. The second application fare rule is the base fare and the rule supposed to be applied when the first determined flight and the second selected flight are included in the target flight.

The step of judging, by the heuristic flight inquiry system, the second application fare rule including the base fare and the rule to be applied to a selected route ( [symbol] target flight [symbol] [symbol] ) according to selection of the second selected flight may include: comparing a base fare corresponding to the first application fare rule with a base fare corresponding to the second selected flight; and judging a fare rule corresponding to a higher base fare to be the second application fare rule.

The step of judging, by the heuristic flight inquiry system, the second application fare rule including the base fare and the rule to be applied to the target flight according to selection of the second selected flight may include: judging, by the heuristic flight inquiry system, whether or not a first journey of the first selected flight and a second journey of the second selected flight are consistent with the first application fare rule that is being currently applied; and when the first journey and the second journey are judged to be in consistent with the first application fare rule, judging a fare rule corresponding to a lowest base fare of fare rules consistent with the first journey and the second journey to be the second application fare rule.

The heuristic flight inquiry method may further include: receiving, by the heuristic flight inquiry system, a determination cancellation request for at least one of the first determined flight and the second determined flight; and in response to the received determination cancellation request, excluding at least one of the first determined flight and the second determined flight from determined flights of the target flight.

The heuristic flight inquiry method may further include, when the second selected flight is inconsistent with the first determined flight or at least a predetermined period of time is situated between the second selected flight and the first determined flight, providing pertinent notice information to the terminal.

The heuristic flight inquiry method may further include: receiving a cancellation request for cancellation of the first determined flight from the terminal according to selection of the second selected flight; and in response to the received cancellation request, determining the second selected flight as the second determined flight of the target flight and excluding the first determined flight from determined flights of the target flight.

The step of having, by the heuristic flight inquiry system, one of the second flights selected as the second selected flight for the second selection segment based on the information about the second flights may include: in response to an inquiry request for the second selected flight, judging, by the heuristic flight inquiry system, overall fare information corresponding to the target flight of a case in which the second selected flight is determined as the determined flight; displaying the judged overall fare information on the terminal; and having the second selected flight selected from the terminal based on the displayed overall fare information. The overall fare information is determined based on the second selected flight and flights previously determined when the second selected flight is requested to be inquired about.

The heuristic flight inquiry method may further include providing, by the heuristic flight inquiry system, determination status information to the terminal, the determination status information including information about previously-determined segments on routes from the departure city to the destination city.

The heuristic flight inquiry method may further include providing information about a second destination, which is not included in the market, and at which the user is able to arrive using the route map, or a second departure, which is not included in the market, and from which the user is able to depart using the route map.

The heuristic flight inquiry method may further include, in response to a request from the terminal, changing the second destination or the second departure to the first destination or the first departure.

The route map may include information about the departure city, the destination city, and segments of the routes depicted and displayed on a map.

In order to overcome the technical problem, an embodiment of the present invention provides a heuristic flight inquiry method of selecting a target flight for a market in which a departure city and a target city are paired. The method heuristic flight inquiry may include: providing, in a heuristic flight inquiry system, a route map of an airline corresponding to the market to a terminal of a user, wherein the route map is a set of routes from the destination city to the target city allowable by fares and rules of the airline, one of the routes including one or more segments; and having, in the heuristic flight inquiry system, a flight selected from the terminal, the selected flight corresponding to a segment to be included in the target flight based on the route map. The step of having, in the heuristic flight inquiry system, the flight input from the terminal includes: when the flight is selected, providing, in the heuristic flight inquiry system, the terminal with an application fare rule including a base fare and a rule to be applied to the target flight and overall fare information to be applied to the target flight according to selection of the flight; and having the flight selected from the terminal based on the application fare rule and the overall fare information.

The heuristic flight inquiry method may be recorded as a program in a computer readable storage medium.

In order to overcome the technical problem, an embodiment of the present invention provides a heuristic flight inquiry system for selecting a target flight for a market in which a departure city and a target city are paired. The heuristic flight inquiry system may include: an interface module for communicating with a terminal of a user; a routing module providing a route map of an airline corresponding to the market to the terminal through the interface module, wherein the route map is a set of routes from the destination city to the target city allowable by fares and rules of the airline, one of the routes including one or more segments; and a control module providing information about first flights corresponding to a first selection segment based on the route map to the terminal, the first selection segment including a single segment or a set of a plurality of connected single segments, having one of the first flights selected as a first selected flight for the first selection segment based on the information about the first flights, determining the first selected flight as a first determined flight of the target flight, and determining a flight corresponding to a remaining segment of the first selection segment of the target flight.

The control module may further provide information about related flights corresponding to related segments of the first selection segment to the terminal. The related segments are defined as segments including the departure city or the destination city of the first selection segment or segments included in the route map and predetermined to correspond to the first selection segment by the heuristic flight inquiry system.

The control module may provide the terminal with information about base fares of reservable booking classes of first flights that depart within predetermined marginal dates with respect to a reference departure date of the first selection segment.

The heuristic flight inquiry system may further include a fare rule module, in response to an inquiry request for the first selected flight, judging a first application fare rule including a base fare and a rule to be applied to the target flight according to selection of the first selected flight. When the first application fare rule judged by the fare rule module is displayed on the terminal, the control module has the first selected flight selected from the terminal based on the displayed first application fare rule.

The heuristic flight inquiry may further include a fare rule module, in response to an inquiry request for the first selected flight, judging overall fare information corresponding to the target flight of a case in which the first selected flight is determined as a determined flight. When the overall fare information judged by the fare rule module is displayed on the terminal, the control module has the first selected flight selected from the terminal based on the displayed overall fare information.

The control module may provide information about second flights corresponding to a second selection segment of the remaining segment to the terminal, has one of the second flights selected as a second selected flight for the second selection segment based on the information about the second flights, and determines the second selected flight as a second determined flight of the target flight.

In response to an inquiry request for the second selected flight, the fare rule module may judge a second application fare rule including a base fare and a rule to be applied to the target flight according to selection of the second selected flight. When the second application fare rule judged by the fare rule module is displayed on the terminal, the control module may have the second selected flight selected based on the displayed second application fare rule. The second application fare rule is the base fare and the rule are supposed to be applied when the first determined flight and the second selected flight are included in the target flight.

The fare rule module may compare a base fare corresponding to the first application fare rule with a base fare corresponding to the second selected flight and judges a fare rule corresponding to a higher base fare to be the second application fare rule.

The fare rule module may judge whether or not a first journey of the first selected flight and a second journey of the second selected flight are consistent with the first application fare rule that is being currently applied, and when the first journey and the second journey are judged to be inconsistent with the first application fare rule, may judge a fare rule corresponding to a lowest base fare of fare rules consistent with the first journey and the second journey to be the second application fare rule.

The control module may receive a determination cancellation request for at least one of the first determined flight and the second determined flight, and in response to the received determination cancellation request, may exclude at least one of the first determined flight and the second determined flight from determined flights of the target flight.

In response to an inquiry request for the second selected flight, the fare rule module may judge overall fare information corresponding to the target flight of a case in which the second selected flight is determined as the determined flight. When the judged overall fare information is displayed on the terminal, the control module may have the second selected flight selected from the terminal based on the displayed overall fare information. The overall fare information is determined based on the second selected flight and flights previously determined when the second selected flight is requested to be inquired about.

The control module may provide determination status information to the terminal through a determination status user interface (UI), the determination status information including information about previously-determined segments on routes from the departure city to the destination city.

The heuristic flight inquiry system may further include a map module depicting and displaying cities corresponding to the route map and segments of the routes on a map.

In order to overcome the technical problem, an embodiment of the present invention provides a heuristic flight inquiry system for selecting a target flight for a market in which a departure city and a target city are paired. The heuristic flight inquiry system may include: a routing module providing a route map of an airline corresponding to the market to a terminal of a user, wherein the route map is a set of routes from the destination city to the target city allowable by fares and rules of the airline, one of the routes including one or more segments; a control module having a flight selected from the terminal, the selected flight corresponding to a segment to be included in the target flight based on the route map; and a fare rule module. When the flight is selected, the control module provides the terminal with an application fare rule including a base fare and a rule to be applied to the target flight and overall fare information to be applied to the target flight according to selection of the flight, and has the flight selected from the terminal based on the application fare rule and the overall fare information provided thereto.

### Advantageous Effects

According to the spirit of the present invention, at least one parameter from among a large number of parameters (e.g. airlines, routes, stopovers, and the like) to be considered in inquiry and/or reservation of airline tickets is heuristically determined by a user in person to be consistent with his or her preferences and travel plans, based on a combination of various pieces of information (e.g. fares, fare rules, route maps, and the like) provided to the user. This reduces the number of parameters to be considered by the system in searching for airline tickets. A decrease in the number of parameters to be considered may exponentially reduce the amount of search time, such that airline tickets can be searched for by considering more cases (or more complex rules applied thereto). Accordingly, higher-quality search results (e.g. cheaper airline tickets) can be provided to the user.

In addition, in the related art, the user is in a passive position in which he or she must simply follow given rules of airline tickets. In contrast, the spirit of the present invention allows the user to examine fares and/or rules of airline tickets by his or herself and select portions of airline tickets, i.e. portions of the journey, based on examined information. Accordingly, the user can actively design the journey and inquire about and/or reserve airline tickets consistent with the journey.

Furthermore, according to the spirit of the present invention, the user can select from routes intuitively displayed on a map, such that a variety of journeys can be intuitively designed.

In addition, it is possible to not only provide search results for airline tickets consistent with conditions input by the user, but also allow the user to design a variety of journeys (e.g. journeys using other destinations or departures to which the same routing is applied) by using the same or similar fares.

Furthermore, changes in fares and rules according to the selection of the user and changes in the price of airline tickets for the entire journey may be presented to the user during reservation of flights for the entire journey, such that the user can efficiently design the journey.

### DESCRIPTION OF DRAWINGS

A brief description is given for the enhancement of understanding of the accompanying drawings to be referred to in the description of the present invention, in which:

FIG. 1 is a view illustrating a fare driven flight inquiry (reservation) method of the related art;

FIG. 2 is a view illustrating a schedule driven flight inquiry (reservation) method of the related art;

FIG. 3 is a view illustrating a schematic configuration of a heuristic flight inquiry system according to an embodiment of the present invention;

FIG. 4 is a view schematically illustrating a process of specifying a route map according to the embodiment of the present invention;

FIG. 5 is a view schematically illustrating a process of heuristically inquiring about a flight according to the embodiment of the present invention; and

FIG. 6 to FIG. 17 are views illustrating examples of the process by which airline tickets are inquired about according to a heuristic flight inquiry method according to an embodiment of the present invention.

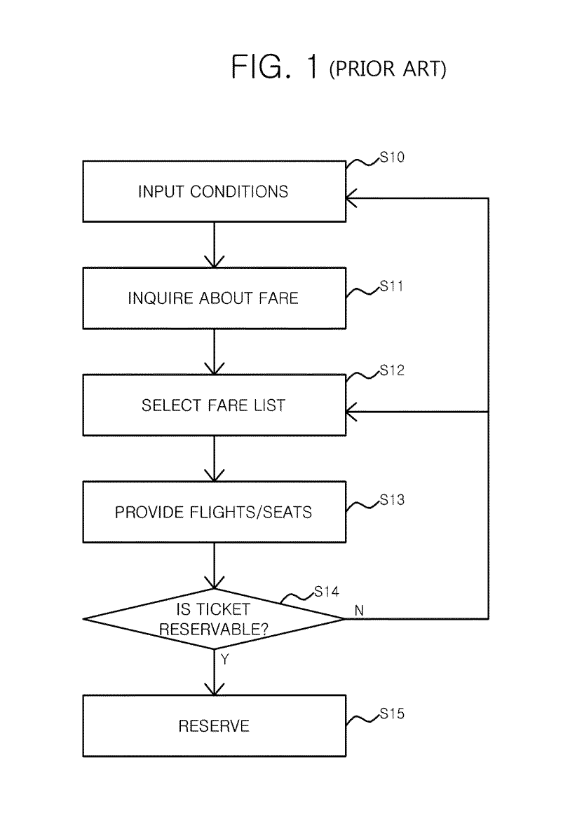

### BEST MODE

Advantages of the present invention associated with operations and objects that may be realized by the practice of the present invention will be apparent with reference to the accompanying drawings illustrating exemplary embodiments of the present invention and from the following description of the accompanying drawings.

Herein, it will be understood that, when an element is referred to as “transmitting” data to another element, the element can not only directly transmit data to another element but also indirectly transmit data to another element via at least one intervening element.

In contrast, when an element is referred to as “directly transmitting” data to another element, the element can transmit the data to another element without an intervening element.

The present invention will now be described more fully hereinafter with reference to the accompanying drawings, in which exemplary embodiments thereof are shown. The same reference numerals and signs are used throughout the different drawings to designate the same components.

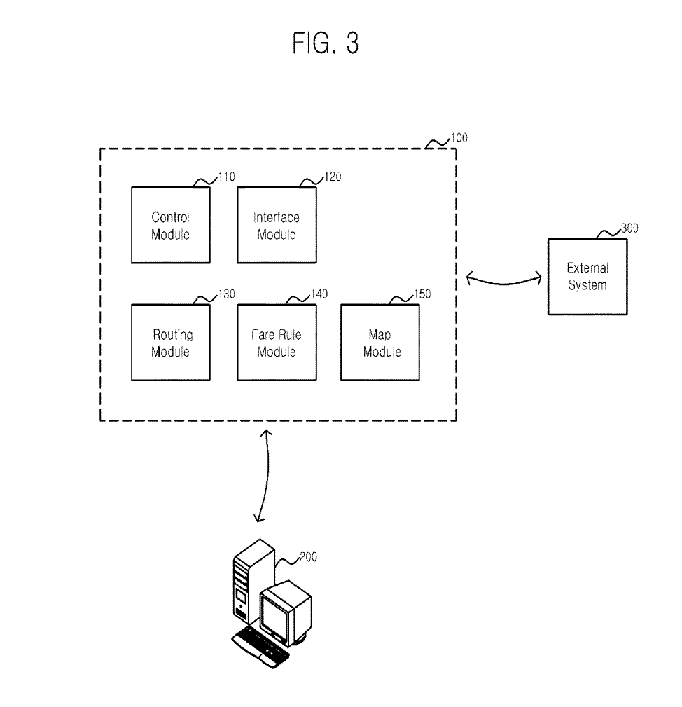

FIG. 3 is a view illustrating a schematic configuration of a heuristic flight inquiry system according to an embodiment of the present invention.

Referring to FIG. 3, a heuristic flight inquiry system according to the embodiment of the present invention can embody the spirit of the present invention while communicating with a user terminal 200 by means of a wired/wireless network. The terminal 200 may be defined as any type of terminal used to inquire about flights to the heuristic flight inquiry system 100. Although a desktop computer is illustrated as an example in FIG. 3, the terminal may be any type of terminal, such as a mobile terminal, internet protocol TV (IPTV), or the like, that can embody the spirit of the present invention while communicating with the heuristic flight inquiry system 100. The terminal 200 may be a terminal, for example, used not only by a user who desires to inquire about flights, but also by personnel, such as employees of a tourist bureau or employees of an airline, who professionally inquire about flights.

The heuristic flight inquiry system 100 is a system that can inquire about flights and can provide inquired-about information to the terminal 200. The heuristic flight inquiry system 100 not only can inquire about flights, but can also reserve a flight selected using the terminal 200 from among the inquired-about flights. Thus, the heuristic flight inquiry system 100 not only indicates a system able to inquire about flights, but may also indicate a system able to reserve an inquired-about flight as required.

The heuristic flight inquiry system 100 can embody the spirit of the present invention while communicating with an external system 300 by means of a wired/wireless network. The external system 300 may indicate at least one system that stores information regarding the inquiry and/or reservation of flights. As an example, the external system 300 may include at least one among an airline tariff publishing company (ATPCO) system, an official airline guide (OAG) system, a global distribution system (GDS), or an airline system operated by an airline, or may include a system mediating necessary information between the at least one system and the heuristic flight inquiry system 100 in order to embody the spirit of the present invention.

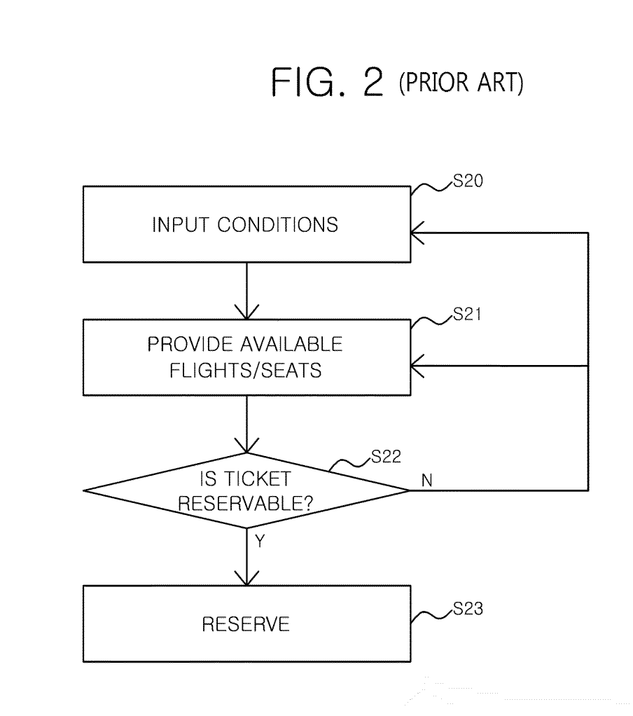

Herein, it will be assumed that the heuristic flight inquiry system 100 can inquire about flights satisfying desirable conditions through communicating with the external system 300 in order to clarify the technical features of the present invention. An algorithm for inquiring about flights may be implemented in various embodiments. A detailed description thereof will be omitted since such an algorithm has already been used as described with reference to FIG. 2 and is not directly related to the technical features of the present invention.

The heuristic flight inquiry system 100 according to the technical features of the present invention may have an effect that is especially advantageous for inquiring about and/or reserving flights for a series of journeys including a plurality of segments.

Herein, the segment may refer to a portion of a journey that can be traveled using a single flight coupon. In addition, the flight coupon may indicate at least a portion of a ticket that must be submitted to an airline representative during boarding of a flight.

For example, in the case of a journey between cities in the sequence of city A, city B, and city C, when a trip from city A to city B is possible using a single flight coupon, the trip from city A to city B may be a single segment. In addition, when a trip from city B to city C is possible using a single flight coupon, the trip from city B to city C may be a single segment. In some implementations, a consecutive trip in the sequence of cities A, B, and C may be possible using a single flight coupon. In this case, the trip in the sequence of cities A, B, and C may be a single segment. A detailed description of the segment will be omitted, since the concept thereof is widely known in the airline industry.

As described above, in flight inquiry and/or reservation methods of the related art, it is theoretically impossible to provide optimal flights to a user by inquiring about flights in real time. Thus, a method of only specifying fares (fees) without consideration of the schedule of the user and providing information regarding airline tickets (flights) available at specified fares (a fare driven method) or a method of autonomously inquiring about adequate airline tickets (instead of optimal airline tickets) and providing the inquired-about airline tickets to the user using a system (a schedule driven method) has been used. This method is used in the related art because an increase in a single parameter (e.g. stopovers, the number of stopovers, transits, the range of fares, the type of a priceable unit (PU), and a variety of factors selectable depending on fare rules) causes an exponential increase in the amount of time for deriving a result of an inquiry (search), thereby making it impossible to provide a real-time service.

Thus, in order to inquire about and/or reserve airline tickets (or flights) for a journey including a plurality of segments, the number of parameters to be considered to inquire about optimal airline tickets (e.g. cheapest airline ticket satisfying given conditions) must be increased, and the result of inquiry must become worse by as much as the increased number of parameters. That is, it is impossible to inquire about all possible solutions regardless of which algorithm is used. There is no choice but to inquire about only some possible solutions and provide the most desirable solutions in the inquiry result. Thus, as in airline tickets including a plurality of segments, the greater the number of parameters to be considered is, the worse the qualities of the inquiry results become. As the number of parameters to be considered increases as in airline tickets including a plurality of segments, the quality of the search result is worsened.

In contrast, according to the spirit of the present invention, differently from the related art, the service system does not consider all parameters but allows a user to specify some parameters (e.g. a flight in a specific segment, whether or not to stop over a place, or the like), even if an airline ticket includes a plurality of segments. Thus, even in the case of an airline ticket including a plurality of segments, the service system (the heuristic flight inquiry system 100 according to the present invention) can prevent the number of parameters to be considered from significantly increasing or reduce the number of parameters to be considered, such that the quality of the inquired (searched) results can be significantly improved.

In particular, in the case of an airline ticket including a plurality of segments, there are a vast number of possible solutions, and thus, the range of fares of airline tickets satisfying given conditions may also increase. Thus, even if the user must spend more effort to inquire about and/or reserve airline tickets, the range of benefits that the user obtains can be increased further than is the case in the related art.

The spirit of the present invention may be used for reserving an airline ticket in the case in which the entire journey is defined by a single fare rule and the journey has a plurality of segments. In particular, this example is applicable to a routing policy provided by airlines.

The heuristic flight inquiry system 100 for embodying the spirit of the present invention may include a control module 110, an interface module 120, and a routing module 130. The heuristic flight inquiry system 100 may further include a fare rule module 140 and/or a map module 150.

The heuristic flight inquiry system 100 may include hardware and/or software resources necessary for embodying the spirit of the present invention, but does not necessarily imply the use of a single physical component or a single unit. That is, the heuristic flight inquiry system 100 may be a logical combination of hardware and/or software provided to embody the spirit of the present invention, and as required, may be implemented as a set of components disposed on separate devices to execute their own functions in order to embody the spirit of the present invention. In addition, the heuristic flight inquiry system 100 may be a set of components separately embodied according to their own functions or actions to embody the spirit of the present invention.

For example, the heuristic flight inquiry system 100 may be configured such that portions thereof are disposed on the terminal 200 and/or the external system 300. Specifically, a component (e.g. the map module 150) of the heuristic flight inquiry system 100 may be distributed to physical units for embodying the terminal 200 and the heuristic flight inquiry system 100, and distributed portions of the component may be systematically combined to form the map module 150. Likewise, a component of the heuristic flight inquiry system 100 may be distributed in the external system 300.

In the specification, the term “module” may refer to a functional and/or structural combination of hardware for realizing the spirit of the present invention and software allowing the hardware to operate. For example, the module may indicate a logical unit of codes and hardware resources executing the codes. It will be apparent to a person skilled in the art to which the present invention pertains that the module does not necessarily indicate either physically-connected codes or only a single type of hardware.

The control module 110 can control resources and/or functions of the other components (e.g. the interface module 120, the routing module 130, the fare rule module 140, and/or the map module 150) of the heuristic flight inquiry system 100 in order to realize the spirit of the present invention.

The interface module 120 can communicate with the user terminal. The other components (e.g. the control module 110, the routing module 130, the fare rule module 140, and/or the map module 150) of the heuristic flight inquiry system 100 can communicate with the terminal 200 or the external system 300 through the interface module 120.

The routing module 130 may provide a route map, corresponding to markets that the user desires, to the terminal 200 via the interface module 120. The route map may mean information that defines routing provided by airlines.

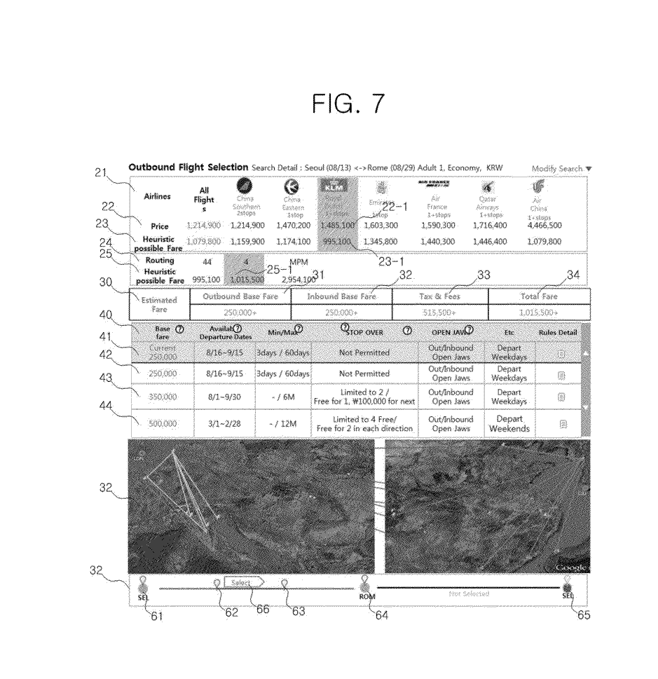

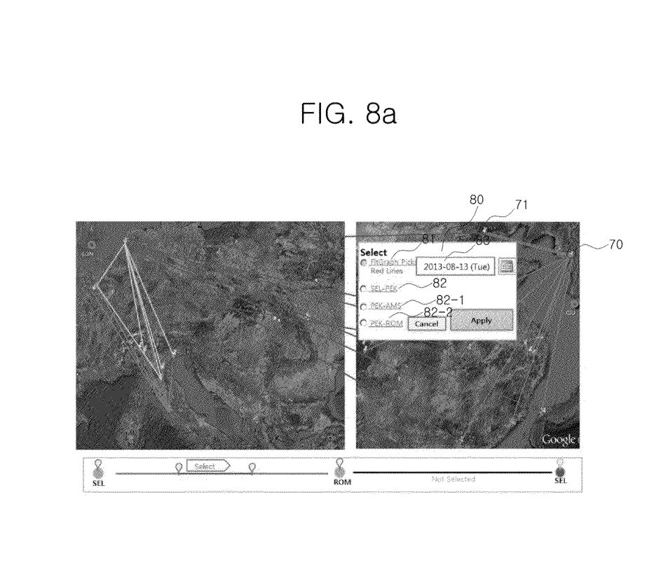

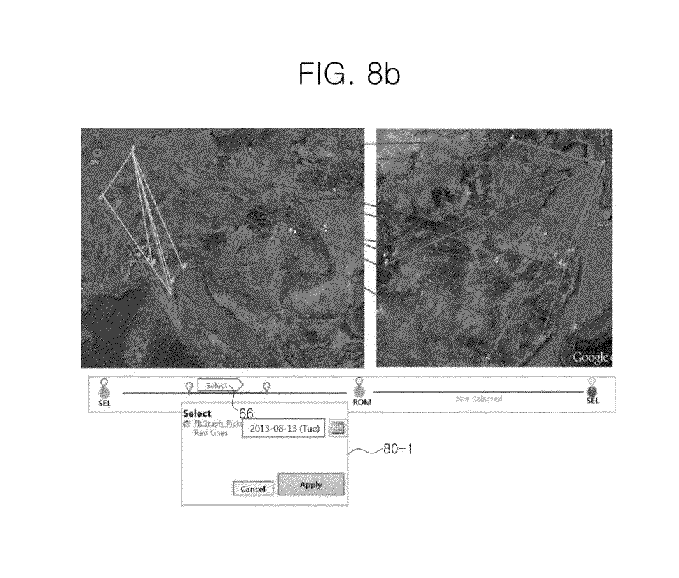

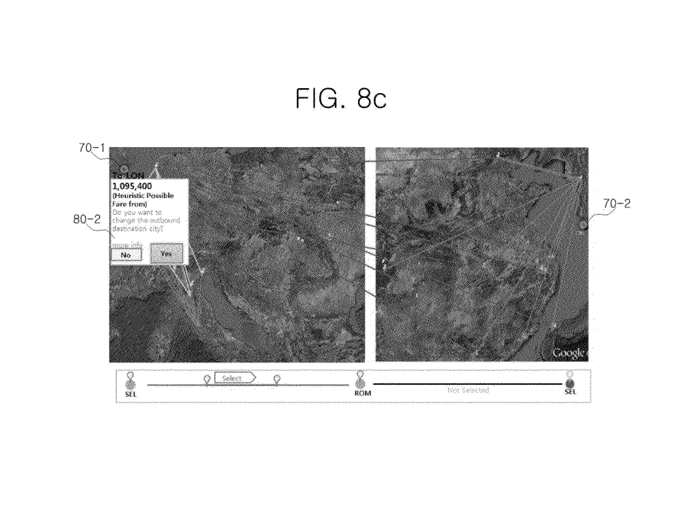

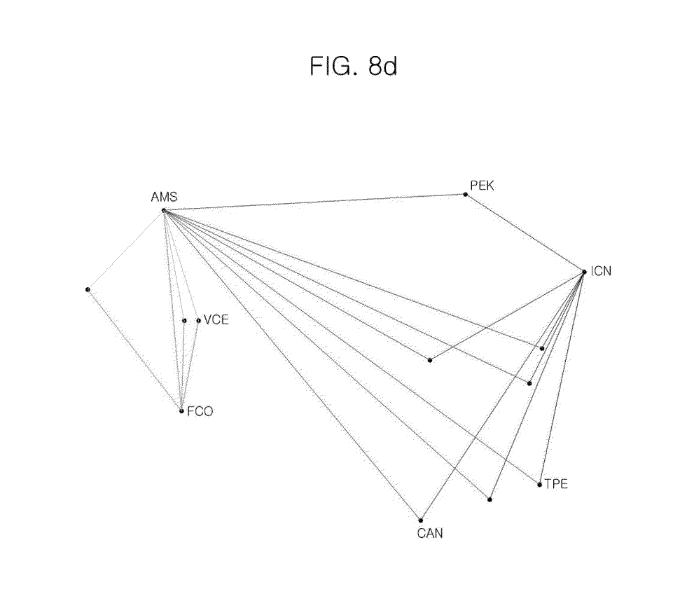

The route map may mean a set of one or more routes from a departure city to a destination city corresponding to the markets, allowed by the fares and rules of airlines that provide services for the markets. In addition, the markets may mean a pair of cities including the departure city and the destination city. The route map includes information about stopovers (stopover cities) existing on the routes. Here, different stopovers may be present on the routes, respectively. The route map according to the embodiment of the present invention may be provided to the user, as illustrated in FIG. 7 and FIG. 8, with respective routes corresponding to the route map being depicted on a map, such that the user can intuitively understand the route map. However, the route map may be depicted on a map to be provided to the user but may be provided in the form of a text series.

For example, the route map according to the embodiment of the present invention may be a route map corresponding to markets of a specific airline including Incheon as a departure city and Rome as a destination city, as will be described later with reference to FIG. 7 to FIG. 17. An example of the route map will be described with reference to FIG. 8d.

FIG. 8d is a view illustrating a part of the route map illustrated in FIG. 8a to FIG. 8c with the map part being eliminated for the sake of brevity. Hereinafter, the terms used in the specification and the route map according to the spirit of the present invention will be described with reference to FIG. 8d.

As illustrated in FIG. 8d, the route map may be a set of routes from the departure city (Incheon (ICN)) to the destination city (Rome (FCO)).

For example, ICN-PEK-AMS-FCO may be a first route, while ICN-TPE-AMS-VCE-FCO may be a second route. In addition, the route map may include information about one or more stopovers on the routes (e.g. PEK and AMS on the first routes and TPE, AMS, and VCE on the second routes).

Each of the routes may include one or more segments. Here, the term “segment” may mean a portion of a journey that can be traveled using a single flight coupon. For example, on the first route, ICN-PEK, PEK-AMS, and AMS-FCO may be single segments, respectively. The definition of the segment is not limited to a leg, i.e. a pairing of two cities that can be traveled on a flight. For example, when a single flight departing from ICN stops at PEK during travel to AMS, a single flight coupon covers a trip from ICN to AMS. In this case, ICN-PEK-AMS may form a single segment. In addition, the segment ICN-PEK-AMS may include two legs ICN-PEK and PEK-AMS. The flight coupon may be a portion of an airline ticket that a passenger must submit to an airline representative during boarding of a flight.

Thus, the route map means information about one or more routes, each of which may be formed as one or more segments.

For example, airlines may allow a plurality of connected segments to be reserved simultaneously. This case is also referred to as married segments. That is, the married segments mean the connected segments, seats of which are managed in concert. When the connected segments are reserved simultaneously, seats are provided (i.e. a reservation is possible). When the connected segments are divided into respective segments, seats may not be provided (i.e. reservations may be impossible).

As described above, the route map according to the embodiment of the present invention may be provided to the user terminal 200, with the routes, segments, or legs thereof being depicted on the map, as illustrated in FIG. 8d. However, in some implementations, the route map may be provided in the form of a text series to the user terminal 200. For example, the first route may be expressed as a text “ICN-PEK-AMS-FCO” when provided to the terminal 200.

In any case, the routing module 130 may provide a route map, corresponding to markets that the user desires, to the user terminal 200.

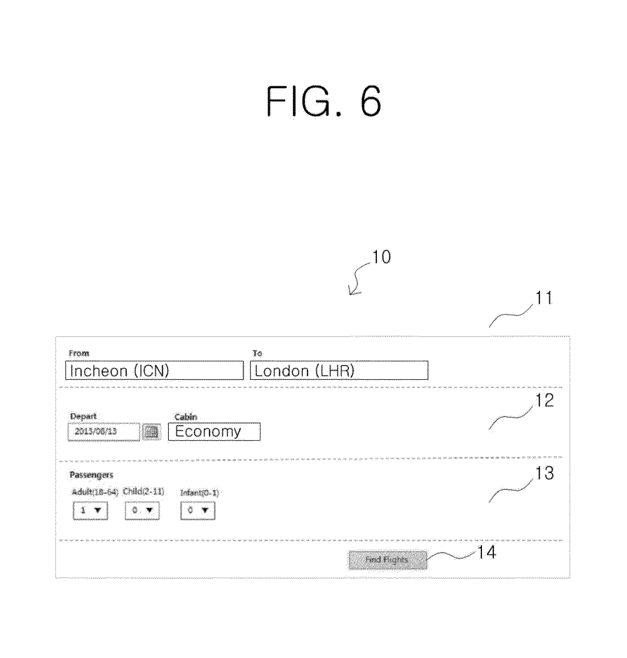

The routing module 130 may receive condition information, i.e. information about conditions of a journey that the user desires, from the terminal 200 through the interface module 120 in order to specify the route map. The conditions may include information about the markets and may further include information about a departure date, a seat class, and the like. It is preferable that the conditions are information that may specify a portion of the entirety of the journey. That is, the routing module 130 is not required to receive conditions able to specify the entirety of the journey. This is because, according to the spirit of the present invention, the user is allowed to select a journey that is not identical to the conditions input by the user (e.g. change a destination city or a departure city, change a departure date or each segment's departure date, or the like), thereby actively designing his or her journey based on information provided by the heuristic flight inquiry system 100. Then, the routing module 130 can specify information about the route map corresponding to the received condition information. This example will be described with reference to FIG. 6.

Referring to FIG. 3 and FIG. 6, the routing module 130 may receive condition information, based on which a portion of the entirety of the journey can be specified, through the interface module 120. In this regard, the routing module 130 may provide a user interface (UI) 10, through which the condition information can be input, to the terminal 200. The UI may include a first UI 11, through which markets (two cities), i.e. the departure city and the destination city, are to be input, a second UI 12, through which the departure date is to be input, and a third UI 13, through which information about a traveler or travelers is to be input. According to the embodiment of the present invention, the flight to be inquired about, i.e. a target flight for the entirety of the journey, may be a flight having the conditions illustrated in FIG. 6 as outbound conditions. It is preferable that the condition information to be received from the terminal 200 in order to realize the spirit of the present invention relates to conditions able to specify a portion of the entirety of the journey (e.g. outbound conditions). In addition, according to the spirit of the present invention, only the most basic pieces of information (e.g. market information) of the received condition information may be used, while the remaining pieces of information of the received condition information may not be considered as parameters to inquire about the target flight. This is because, according to the spirit of the present invention as will be described later, the object of the present invention can be realized (i.e. the user is allowed to actively design his or her journey) by performing the search using conditions to be basically considered and allowing the user to adaptively change the other conditions based on information provided to the user.

In the embodiment of the present invention, an example in which the target flight to be inquired about and/or reserved using the heuristic flight inquiry system 100 is a round trip flight will be described. Thus, according to the embodiment illustrated in FIG. 6, no inbound conditions may be input in this example. Since the inbound conditions may be adaptively selected according to the selection of the user, the inbound conditions may not be necessary for the reservation of the target flight.

In the case in which the condition information is input through the UI 10, when the terminal 200 transmits an inquiry request to the routing module 130 through a fourth UI, the routing module 130 can specify the route map corresponding to the condition information.

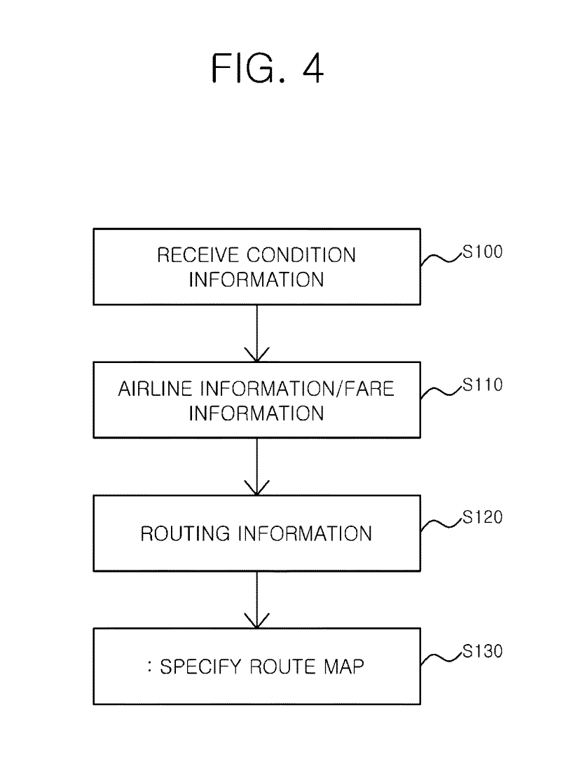

A process of specifying a route map will be described with reference to FIG. 4 and FIG. 7.

Referring to FIG. 3, FIG. 4, and FIG. 7, the routing module 130 may receive condition information through the interface module 120 (S100). Then, the routing module 130 may inquire about routing information, i.e. the identification information of a plurality of route maps corresponding to the condition information, e.g. 24, through the external system 300 and provide a plurality of pieces of inquired-about routing information to the terminal 200 (S120). In some implementations, the routing module 130 may provide airline information, e.g. 21, corresponding to the condition information, and/or airline-specific fare information 22 to the terminal 200 (S110), and when a specific airline (e.g. KLM air) is selected using the terminal 200 based on the provided airline information, may provide the routing information, e.g. 24, of one or more route maps that the selected airline provides to the terminal 200.

Then, among the routing information provided to the terminal 200 (e.g. route 44 and route 4), any piece of routing information (e.g. route 4) may be selected using the terminal 200. Then, a route map corresponding to the selected piece of routing information (e.g. route 4) may be specified as a route map to be provided to the terminal 200 (S130). In addition, information about heuristic-possible fares 25 according to each piece of routing information may be further provided to the terminal 200. When the terminal 200 selects a specific piece of routing information, information about a route map 50 corresponding to the selected piece of routing information may be provided to the terminal 200. The user may examine the information about the route map 50 provided to the terminal 200 and select a desirable piece of routing information (e.g. route 4). The example of FIG. 7 represents a case in which the user selects route 4 based on the provided route maps although the heuristic-possible fares corresponding to route 44 are cheaper than the heuristic-possible fares corresponding to route 4.

The routing module 130 may inquire about fare information (e.g. prices) corresponding to the condition information according to airlines and may provide inquired-about fare information to the terminal 200. The fare information may mean the lowest fare of the flights judged by the heuristic flight inquiry system 100, from among the target flights able to satisfy the currently-input conditions. That is, the fare information 22 may mean the lowest fare of the flight according to the airline, able to satisfy the current condition information. The fare information 22-1 (e.g. 1,485,100) of airline (e.g. KLM) may be the lowest fare of the target flight that can be reserved while satisfying the currently-input condition information. The expression that the routing module 130 inquires about fare information, heuristic-possible fares, or overall fare information as will be described later may be interpreted as including an operation of inquiring about the same through the fare rule module 140.

The heuristic-possible fares 23 searched for by the routing module 130 may be the lowest fares for a market (e.g. for a flight between Seoul and Rome) included in the condition information. Specifically, the heuristic-possible fares 23 may be possible lowest fares according to airlines for round trip travel for the market and may be fares judged without consideration of the condition information other than the market (e.g. journey schedules, reservation statuses of flights, or the like). Thus, actually, the user may or may not reserve a round trip flight for the market, i.e. a target flight, at the heuristic-possible fare.

The user may compare fare information, e.g. 22-1, of a specific airline with a heuristic-possible fare, e.g. 23-1, when the two fares are the same or have no significant difference, and may inquire about and/or reserve the target flight corresponding to the fare information, e.g. 22-1 (i.e. the target flight reservable at the pertinent fare information).

A significant difference between the fare information, e.g. 22-1, and the heuristic-possible fare, e.g. 23-1, indicates a possibility that the user will reserve the target flight for the market at the heuristic-possible fare, e.g. 23-1, or a fare close to the heuristic-possible fare, e.g. 23-1, by changing a portion of his or her plan for the journey (e.g. a stopover city, a departure date, a transit date, or the like). Thus, it is possible to inquire about and/or reserve the target flight according to the spirit of the present invention.

The routing module 130 may inquire about the airline-specific fares through the fare rule module 140 of the heuristic flight inquiry system 100. The fare rule module 140 can inquire about information regarding a variety of fares (e.g. airline-specific lowest fares, flight-specific base fares, routing-specific heuristic-possible fares, overall fare information, and the like) defined in the present invention, through the external system 300. In this specification, an expression that some component inquires about or acquires information regarding fares may indicate that the component inquires about or acquires information regarding fares using the fare rule module 140.

As illustrated in FIG. 7, a specific airline (e.g. KLM air) can provide a plurality of routing (e.g. routing 44 and routing 4) corresponding to the condition information, in which a lowest fare, e.g. 995,100, from among heuristic-possible fares, e.g. 25, for the plurality of routing may be the heuristic-possible fare, e.g. 23-1, of the specific airlines (e.g. KLM air).

The airline-specific heuristic-possible fare, e.g. 23, and/or airline's routing-specific heuristic-possible fares, e.g. 25, are provided to the terminal as described above because the fare is the most important factor to be considered for a specific user, who may be eager to change at least a portion of the initially-selected conditions (e.g. the departure date, the grade, the airline, even the departure city or the destination city, and the like) when a cheaper fare is available. Thus, according to the spirit of the present invention, information about the heuristic-possible fares and/or information about the route map are provided. Thus, not only flights (including a plurality of flights) satisfying conditions input by the user are inquired about, but also journeys that may be judged to be more satisfying than the originally-planned journey and fares of the more satisfying journeys may be presented to the user, such that the user can refer to any of the more satisfying journeys and the fares in the process of inquiring about and/or reserving an airline ticket. In addition, the plan for the journey can be changed due to the route map and information regarding fare rules being provided to the terminal 200.

According to the spirit of the present invention, although the user may simply inquire about a target flight satisfying the conditions, the user may heuristically determine and/or design a flight that he or she desires, based on the heuristic-possible fares, fare rules 40, the route maps, and the like.

The map module 150 of the heuristic flight inquiry system 100 may provide the route map 50 to the terminal 200 by depicting the route map 50 on the map as illustrated in FIG. 7. When the route map is specified by the routing module 130, the map module 150 provides the specified route map to the terminal 200 by depicting the route map on the map as illustrated in FIG. 7, such that the user can intuitively select an available stopover or a segment included in the target flight.

In this specification, when some component transmits the route map to the terminal 200 or uses, corrects, or changes the route map, a person skilled in the art to which the present invention pertains will readily appreciate that the route map depicted on the map may be transmitted, used, corrected, or changed through the map module 150. For example, the routing module 130 and/or the control module 110 may provide route map information generated by the map module 150 to the terminal 200 or may correct or change the route map information generated by the map module 150 (for example, such that a route corresponding to the selected flight is distinguishable from the other routes).

As the map module 150 provides the route map depicted on the map as described above, a city or a place that has not been included in the original plan for the journey may be added to the journey. Therefore, the spirit of the present invention is not intended to be limited to simply inquiring about a flight corresponding to a planned journey. In contrast, according to the spirit of the present invention, the user may be allowed to design a journey during the process of inquiring about and/or reserving a flight based on pieces of information (e.g. possible routes, stopovers, overall fare information (i.e. fares of entire journeys) when segments included in the route maps are selected, fare rules of a flight selected by the user, and the like) provided to the user.

For example, the user may examine segments or legs that he or she can select by examining the route map 50. Thus, the user can intuitively examine stopovers that he or she can select, thereby adaptively designing his or her journey. For example, the user can understand from the route map 50 that he or she can travel to the destination city by stopping over Taipei TPE. In addition, the user may be reminded of a friend living in Taipei TPE. Although the user did not originally intend to visit the friend's home according to the original journey plan, he or she may design a new journey (i.e. a journey to which a new plan is added) based on the route map 50 provided from the heuristic flight inquiry system 100. In addition, when the new journey is planned, it is possible to intuitively examine overall fare information about the case in which the new plan is added and the case in which new plan is not added, as will be described later. Thus, there is an effect in that a reasonable journey can be designed according to a change in the fare.

In addition, the control module 110 of the heuristic flight inquiry system 100 may provide determination status information as illustrated in FIG. 7. The determination status information 60 may represent information about a segment that the user is currently selecting or segments that have already been selected. The determination status information 60 may display a plurality of segments of a specific routing through a departure city UI 61, one or more segment dividing UIs 62 and 63, and a destination city UI 64. In addition, the determination status information 60 may include a selection UI 66 displaying a segment, a flight for which is to be selected by the user at present. FIG. 7 illustrates an example of the determination status information 60 displayed on the terminal 200 when selecting an outbound journey. When an inbound journey is to be selected, one or more segment dividing UIs, for example, 62 and 63, may be further displayed between an inbound departure city, for example, ROM 64, and an inbound destination city, for example, SEL 65.

The control module 110 may provide estimated fare information 30 to the terminal 200. The estimated fare information 30 may also carry out an important role for the user to adaptively or actively design the journey. The estimated fare information 30 may be inquired about by the fare rule module 140, as described above. An example in which the estimated fare information 30 inquired about by the fare rule module 140 is provided to the terminal 200 will be described with reference to FIG. 7.

Referring to FIG. 3 and FIG. 7, the routing module 130 may transmit information about the specified route map 50 to the terminal 200. In addition, as described above, the routing module 130 may further provide pieces of information corresponding to the condition information, such as the airline information 21, the airline-specific fare information 22, information about the airline-specific heuristic-possible fares 23, routing information 24, and information about the routing-specific heuristic-possible fares 25, to the terminal 200.

In addition, the control module 110 may further provide the estimated fare information 30 along with these pieces of information to the terminal 200.

As illustrated in FIG. 7, when a specific routing (e.g. routing number 4) is selected by the terminal 200, the routing module 130 may provide a heuristic-possible fare 25-1 (e.g. 1,015,500) of the specific routing (e.g. routing number 4).

Before the user inquires about and/or reserves the target flight according to the spirit of the present invention, the estimated fare information 30 may also be set to correspond to the heuristic-possible fare 25-1 (e.g. 1,015,500).

The estimated fare information 30 may include information about an outbound base fare 31, an inbound base fare 32, tax and fees 33, and a overall fare 34. The overall fare 34 may be a total of the outbound base fare 31, the inbound base fare 32, and the tax and fees 33. The estimated fare information 30 may be information about the fares of the target flights judged based on the selection of the user to the present time.

The user may select the heuristic-possible fare, e.g. 25-1, provided to the terminal 200 in order to heuristically inquire about and/or reserve the flight according to the spirit of the present invention. Then, as illustrated in FIG. 7, the estimated fare information 30, the fare rules 40, the route map 50, and/or the determination status information 60 may be provided to the terminal 200.

The heuristic-possible fare, e.g. 25-1, and the estimated fare information 30 may be the same before an inquiry and/or a reservation is actually performed. In addition, information about the outbound base fare 31, the inbound base fare 32, and/or the tax and fees 33 of the estimated fare information 30 may be changed while the user carries out inquiry and/or reservation in a step-by-step manner. When the user performs an ideal selection of the fare, the above-described pieces of information may not be changed. That is, when the target flight is ultimately reserved, the flight may be reserved at the same fare as the heuristic-possible fare, e.g. 25-1.

The fare rules 40 may include information about application fare rules 41 that are currently applied and one or more base fare rules, e.g. 42, 43, and 44. The base fare rules may include information about base fares and rules applied to the base fares (e.g. available departure dates), minimum/maximum journey periods Min/Max, stopovers, the availability of open jaw tickets, etc.).

Specifically, in the example illustrated in FIG. 7, the first base fare rule 42 prescribes conditions for a first base fare, e.g. 250,000, to be applied, i.e. a departure date is between August 16 and September 15 and is a weekday, the journey may be prolonged for minimum of three days and maximum of sixty days, a stopover is not allowed, and open jaw tickets are allowed in outbound and inbound routes. The second base fare rule 43 prescribes conditions for a second base fare, e.g. 350,000, to be applied, i.e. a departure date is between August 16 to September 30 and is a weekday, the minimum period of the journey is not limited but the journey may be prolonged for maximum of six months, a maximum of two stopovers are allowed, with one stopover being free and 100,000 Korean Won having to be paid for the other stopover, and open jaw tickets are allowed in outbound and inbound routes. Likewise, the third base fare rule 44 prescribes conditions for a third base fare, e.g. 500,000, to be applied, i.e. a departure date is between March 1 to February 28 and is a weekend, the minimum period of the journey is not limited but the journey may be prolonged for maximum of 12 months, a maximum of four stopovers are allowed, with two stopovers being allowed for inbound and outbound routes, respectively, and open jaw tickets are allowed in outbound and inbound routes.

In addition, more detailed rules may be provided to the user when a specific field (Detailed Rules) is selected.

In addition, the application fare rules 41 may be illustrated as fare rules, from among the plurality of base fare rules, e.g. 42, 43, and 44, to be applied to the entire target flights by the current selection of the user (e.g. selection of segment-specific flights, flight departure dates, and the like).

When the application fare rules 41 are changed while the user is performing an inquiry and/or a reservation, the estimated fare information 30 may also be changed.

As described above, the heuristic flight inquiry system 100 provides the estimated fare information 30 and/or the fare rules 40, such that the user may intuitively and efficiently design the journey by understanding which base fare and/or rule are to be applied for the selection of a journey that he or she desires.

In addition, in some implementations, the control module 110 may have one base fare rule from among the base fare rules, e.g. 42 to 44, selected by the terminal 200, such that the user may select a flight for a specific segment. Then, information about flights provided to the user to allow the user to select the flight for the segment may be limited to flights satisfying the selected base fare rule.

In some implementations, the user is only allowed to refer to the fare rule 40 when selecting a flight, and when the user selects a specific flight, the terminal 200 may be notified of which base fare rule is applied according to the selection of the specific flight or whether or not the currently-applied application fare rule is changed.

Regardless, as the fare rules 40 are provided to the user, the user may understand which rule must be followed or which flight must be selected for cheaper fare. When the user is relatively free of schedules or regulations, the use may design an entire journey based on the fare rules 40 in order to inquire about and/or reserve a cheaper target flight.

For example, the user who originally planned to depart during a weekend may be able to appreciate from the fare rules 40 that the first base fare rule 42 or the second base fare rule 43 is applicable when he or she departs during a weekday. Thus, in the process of inquiring about and/or reserving a flight according to the spirit of the present invention, the user may judge whether or not to change his or her plan of departing during a weekend in order to pay for a cheaper fare. In addition, the user may adaptively determine whether or not to select a stopover and whether to select one or two stopovers by referring to rules included in the base fare rules 42, 43, and 44. For example, when the user has examined the fare rules 40 according to the spirit of the present invention as illustrated in FIG. 7 while inquiring about airline tickets, the user may understand that a stopover is allowable when an additional fare of 100,000 Korean Won is paid. Then, the user may adaptively judge which city to have a stopover by referring to the route map 50.

In the related art, the user is simply and unilaterally provided with a flight, the airline ticket of which is not optimal, when the flight satisfies the conditions input by the user. In contrast, in the heuristic flight inquiry system 100 according to the spirit of the present invention, as described above, when a routing is specified, the user can actively and adaptively design his or her journey using information provided by the system, such as the estimated fare information 30, the fare rules 40, and the route map 50.

In addition, according to the spirit of the present invention, the above-described information may be examined in a step-by-step manner when a flight for each segment of a target flight is inquired about and/or reserved. Thus, it is possible to understand which effect on the overall fare is brought or whether or not currently-applied application fare rules are changed by the determination of a flight for a segment which is being inquired about and/or reserved. It is therefore possible to understand, in a step-by-step manner, which segment has the greatest effect on the overall fare or whether or not a cheaper fare is applicable by changing a determined segment.

In particular, according to the spirit of the present invention, the user is allowed to heuristically judge segment-specific flights in a step-by-step manner based on several pieces of information as described above, such that the qualities of subsequent inquiries about or searches for flights can be significantly improved.

For example, the control module 110 may specify a segment i.e. selection segment, to be reserved or selected from among a plurality of segments included in the route map specified by the routing module 130. The selection segment may be selected by the control module 110, may be selected by the terminal 200, or may be ultimately selected by the terminal 200 after being recommended by the control module 110.

Then, the control module 110 can provide information about flights corresponding to the selection segment. Information about flights provided as will be described later may include information about related flights determined based on a predetermined basis. In addition, the user may select one flight based on information about flights provided to the terminal 200. This selection may use the above-described pieces of information, such as the estimated fare information 30, the fare rules 40, and the route map 50, and/or the airline-specific base fares.

When the flight is selected, the control module 110 may determine the selected flight to be a determined flight of the target flight.

In addition, the control module 110 may determine determined flights for the remaining segments of the selection segment in the same manner, in addition to the above-stated selection segment determined for the flight.

Consequently, the control module 110 may have a flight to be used for at least one segment from among the plurality of segments on the route of the target flight, input by the user in person. When the flight to be used for one segment from among the plurality of segments on the route of the target flight is determined as described above, at least one parameter that the heuristic flight inquiry system 100 must consider to search for the target flight corresponding to the condition information is reduced. Consequently, the number of search results to be provided to the user is reduced exponentially, and thus the quality of information about flights applicable to the remaining segments on the route may be very high.

The control module 110 may have a flight to be used for the selection segment in each step, the flight being selected by the terminal 200. The selected flight may be determined as the determined flight of the target flight. The determined flight may be a flight that is temporarily selected before flights for all segments of the target flight are ultimately determined. In addition, as will be described later, the temporarily-determined flight may later be canceled by the user. That is, in the process of selecting flights for segments in a step-by-step manner, the user may judge that the journey may be designed at a cheaper fare or in a more attractive manner by changing a flight selected in the previous step, based on the above-described pieces of information. In this case, it is possible to cancel at least one flight determined as a determined flight. Consequently, the user needs not return to the first step of the process of inquiring about and/or reserving a target flight, and can heuristically judge in each step.

In addition, when a flight is determined for at least one selection segment, the control module 110 may automatically select flights for the remaining segments using an algorithm. That is, the user may not select flights for the entirety of the segments. Alternatively, the flights for the remaining segments may be determined by being sequentially selected by the user.

In any case, according to the spirit of the present invention, at least one segment from among the segments on the route allowed by specific routing may be determined by the selection of the user. This consequently reduces a parameter to be considered when inquiring about flights satisfying optimal conditions (e.g. a lowest fare) that the user desires. When the determined flight is determined, the number of the other flights to be inquired about to specify the target flight may be significantly reduced. Thus, the result of an inquiry about the target flight including the determined flight inquired about by the heuristic flight inquiry system 100 may be high-quality information i.e. reliable information.

Hereinafter, the spirit of the present invention as described above will be described in more detail.

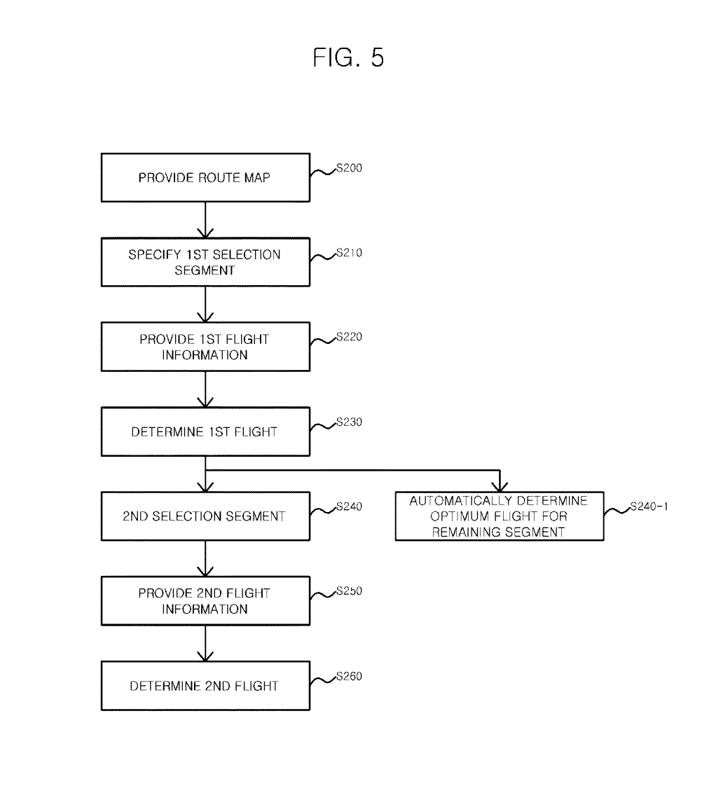

FIG. 5 is a view schematically illustrating a process of heuristically inquiring about a flight according to the embodiment of the present invention.

Referring to FIG. 5, when routing is specified as described with reference to FIG. 4, the heuristic flight inquiry system 100 may provide information about the route map 50 corresponding to the specified routing (S200).

In addition, a first selection segment, a flight which will be heuristically selected by the user, from among a plurality of segments allowed on the routing, may be specified (S210). The heuristic flight inquiry system 100 may recommend a segment based on a predetermined basis, inducing the user to select the recommended segment as a first selection segment, a flight for which will be preferentially selected. The recommended segment may not necessarily be selected as the first selection segment. Alternatively, a segment selected by the user as an discretion may be specified as the first selection segment. In some implementations, the heuristic flight inquiry system 100 may automatically select the first selection segment based on a predetermined basis.

The heuristic flight inquiry system 100 may recommend the first selection segment in a variety of schemes. For example, a segment recommended by the heuristic flight inquiry system 100 (i.e. a segment, a flight for which is recommended to be determined preferentially; hereinafter referred to as a “recommended segment”) may be a segment that is most sensitive to the fare of the target flight or a segment that is the longest on average. In the embodiment of the present invention, the first selection segment may be a transcontinental segment (e.g. a segment indicated by a red line on the route map 50 illustrated in FIG. 7).

As the user is recommended to preferentially determine a flight for the recommended segment, the inquiry results of flights (i.e. available flights for the remaining segments) that have to be inquired about to select flights for the remaining segments may have higher quality.

Alternatively, the segment selected by the user as an discretion may be preferentially selected instead of the segment recommended by the control module 110. This segment will be referred to as the discretionally-selected segment.

The process of selecting the first selection segment is illustrated in FIG. 8a and FIG. 8b.

First, as illustrated in FIG. 8a, the user may select (e.g. touch or click) a city (e.g. PEK 71) on the route map 50 provided to the terminal 200.

The control module 110 may provide a UI 80. The control module 110 may provide a UI 81, through which a recommended segment PEK-AMS from cities selected through the UI 80 is to be selected. The recommended segment may be indicated by a red line on the route map 50. Alternatively, UIs, e.g. 82, 82-1, and 82-2, through which the user will select one of discretionally-selected segments (e.g. SEL-PEK, PEK-AMS, and PEK-ROM), may be provided. The recommended segment may be repeatedly included in the discretionally-selected segments.

In addition, the UI 80 may further include a UI 83, through which a reference date (e.g. a departure date) of a segment to be selected is to be input.

When one of the UIs 81, 82, 82-1, and 82-2 provided through the UI 80 is selected, a segment corresponding to the selected UI may be specified as the first selection segment.

According to another embodiment, the user may select the first selection segment through the selection UI 66 included in the determination status information 60. This example is illustrated in FIG. 8b.

As illustrated in FIG. 8b, the control module 110 may provide the selection UI 66 to the determination status information 60. When the user selects the selection UI 66, a UI 80-1 may be provided as illustrated in FIG. 8b. That is, the selection UI 66 may be a tool for specifying recommended segments. The user may select one of the recommended segments (e.g. red lines) through the UI 80-1. In this regard, UIs (not shown), equivalent to the UIs, e.g. 82, 82-1, and 82-2, described with reference to FIG. 8a, may be provided to display the recommended segments on the UI 80-1. Alternatively, when the user selects the selection UI 66, at least one segment recommended by the control module 110 may be displayed on the route map 50. The recommended segment may be displayed to be distinguished from the other segments. Then, the user may specify the first selection segment by selecting one of the recommended segments (e.g. one of the red lines) on the route map 50.

In addition to these schemes, the user may select the first selection segment as an discretion by selecting a desirable segment on the route map 50 (e.g. by selecting one of lines displayed on the route map 50) in person.

Returning to FIG. 5, when the first selection segment is specified as described above, the control module 110 may provide information about the first flight corresponding to the first selection segment to the terminal (S220).

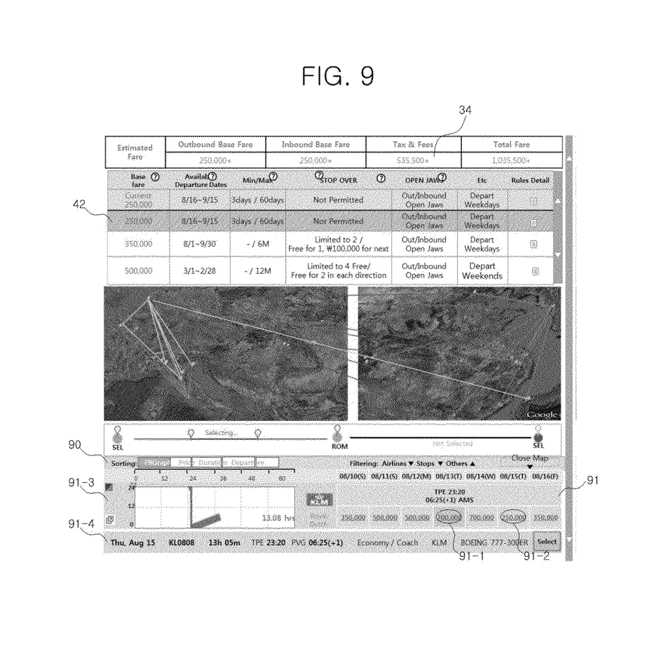

Information about the first flight corresponding to the first selection segment may include information about a flight available for the first selection segment. In addition, the information about a flight may include, for example, information about the airline of the flight, a departure time, an arrival time, and/or base fares, e.g. 91-1 and 91-2. For example, when TPE-AMS is specified as the first segment as illustrated in FIG. 9, information about the flight corresponding to the first selection segment may be flight information 91 included in a flight information UI 90.

In addition, according to the spirit of the present invention, information about flights corresponding to the selection segment provided to the terminal 200 from the control module 110 not only includes information about flights on a specific date corresponding to the reference date (e.g. a departure date: August 13) of the selection segment, but may also include information about flights on dates (e.g. from August 10 to August 16) including marginal dates (e.g. 3 days) before and after the reference date of the selection segment.

As described above, when the control module 110 provides information about flights corresponding to the selection segment, information about the flights corresponding to not only the reference date but also the marginal dates is provided. Thus, according to the spirit of the present invention, the user can adaptively and actively design his or her journey.

For example, as illustrated in FIG. 9, the user is provided with information about the flights corresponding to the marginal dates, such that the user can determined whether or not to stop at the stopover TPE. For example, a flight corresponding to the reference date (e.g. August 13) may be a flight, the base fare of which is 700,000 Korean Won. In this case, the user may examine the fare rules 40 provided by the control module 110 and may examine rules corresponding to the pertinent base fare. Although not illustrated in FIG. 9, for example, when a stopover is allowable by a rule, the base fare of which is 700,000 Korean Won, the user may or may not add a stopover to his or her plan for the journey or may add a stopover at the departure city TPE or a stopover at the destination city AMS of the selection segment to his or her plan for the journey.

In addition, the user may be further provided with information about flights departing on the marginal dates. For example, the user may be able to see that the base fare 91-2 of the flight corresponding to the selection segment TPE-AMS departing on August 15 from among the marginal dates is 250,000 Korean Won. When the user additionally examines information about the flight on the marginal date, the user may consider departing on August 15 by changing his or her plan for the selection segment of departing on August 13. Here, the base fare rule 42 corresponding to the base fare 91-2 may further be considered. The user may examine the base fare rule 42 corresponding to the base fare 91-2, may understand that a stopover is not allowable by the base fare rule 42, and then determine whether or not to select the pertinent flight of August 15 as the flight for the selection segment.

Thus, information about the flights corresponding not only to the departure date of the selection segment but also to the marginal dates may be very important information for the user (in particular, the user having a flexible schedule) to use in order to reserve a flight having a cheaper fare. In addition, since information about the flights corresponding to the marginal dates is provided, the user can actively and adaptively plan the journey according to changes in cost.

In addition, when the first selection segment (e.g. TPE-AMS) is specified, the control module 110 not only provides information about the flights corresponding to the first selection segment (including information about the flights on the marginal dates) to the terminal 200 as described above, but may also provide information about related flights corresponding to related segments related to the first selection segment to the terminal 200.

The related segments may be segments including the departure city or the destination city of the first selection segment. Alternatively, the related segments may be segments included in the route map, predetermined as segments corresponding to the first selection segment by the heuristic flight inquiry system.

For example, when the selection segment is TPE-AMS as illustrated in FIG. 9, a related segment related to the selection segment TPE-AMS may be a segment in which the departure city TPE of the selection segment TPE-AMS is a departure city or a destination city or may be a segment in which the destination city of the selection segment TPE-AMS is a destination city. For example, the related segment may be a segment different from the selection segment TPE-AMS, in which the destination city of the related segment is the same as that of the selection segment TPE-AMS.

In addition, related segments of each segment may be previously defined by the control module 110. The control module 110 may impart a characteristic to each segment and may define segments having the same characteristic as related segments. For example, several cities may be classified as belonging to a first category, and other several cities may be classified as belonging to a second category. When a segment is a trip from a city belonging to the first category to a city belonging to the second category, related segments of the segment may be trips from cities belonging to the first category to cities belonging to the second category.

The related segments are defined as described above, and information about flights corresponding to the related segments is provided to the terminal 200. Thus, after the selection segment (e.g. TPE-AMS) is selected, when a flight, conditions for which are better than those for the flight for the selection segment, is provided to one of the related segments, the characteristics of which are similar to that of the selection segment (e.g. TPE-AMS), the user may change the selection segment (e.g. TPE-AMS) as the related segment.

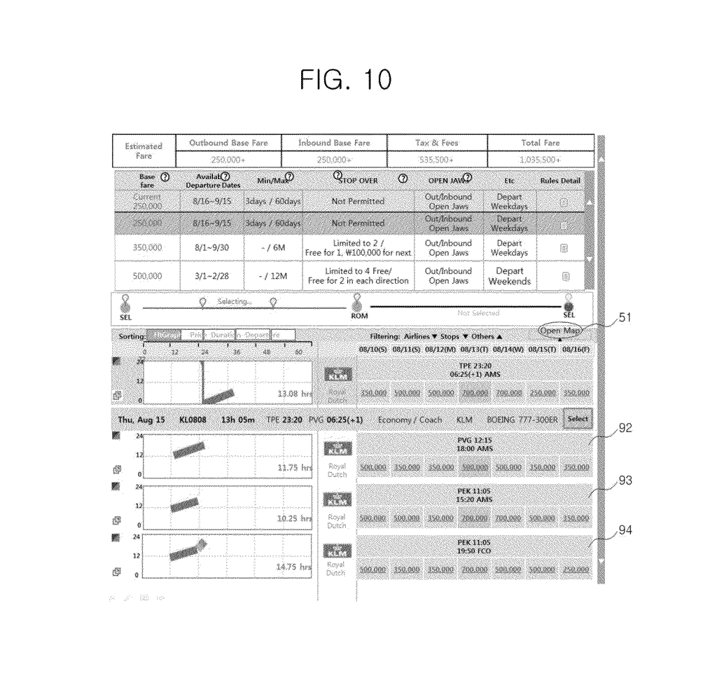

For example, as illustrated in FIG. 9 and FIG. 10, when a selection segment (e.g. TPE-AMS) is specified, the control module 110 may provide not only the flight information 91 corresponding to the selection segment (e.g. TPE-AMS) but also pieces of flight information 92, 93, and 94 corresponding to related segments (e.g. PVG-AMS, PEK-AMS, and PEK-FCO). Here, the first related segment PVG-AMS and the second related segment PEK-AMS may be segments, the destination city (AMS) of which is the same as that of the selection segment (e.g. TPE-AMS).

In addition, the third related segment PEK-FCO may be a married segment including the selection segment (e.g. TPE-AMS) or a married segment including a segment related to the selection segment (e.g. TPE-AMS). In FIG. 10, the third related segment PEK-FCO may be a married segment including the second related segment PEK-AMS.

The user may receive information about the related segments and information about the flights for the related segments from the heuristic flight inquiry system 100, and may preferentially determine a flight from among the flights for the related segments before a flight for the selection segment (e.g. TPE-AMS) that he or she intended to select. That is, the selected related segment may be regarded as being changed to a selection segment.

Returning to FIG. 5, the user may determine the first flight based on information provided after the selection segment (e.g. TPE-AMS) is specified, i.e. information about the flights for the selection segment (e.g. TPE-AMS), the estimated fare information 30, the fare rule 40, and the route map 50 (S230).

Then, the control module 110 may set the determined first flight as a determined flight. That is, the determined first flight may be set as the determined flight that will be included in a target flight.

Then, in some implementations, the heuristic flight inquiry system 100 may automatically determine flights for the remaining segments, from which the target flight is to be determined (S240-1). In this case, a flight that has a lowest fare while satisfying condition information previously-input by the user may be determined.

Alternatively, the above-described process may be performed for the remaining segments. Specifically, the control module 110 may specify one segment from among the remaining segments, from which the target flight is to be determined, as a second selection segment (S240). Then, information about a flight corresponding to the second selection segment, i.e. a second flight, may be provided to the terminal 200 (S250). Information about the second flight may also include not only information about flights corresponding to the reference date of the second selection segment but also information about flights corresponding to the marginal dates. In addition, information about the related segments corresponding to the second selection segment may further be provided.

Then, a flight for the second selection segment, i.e. the second flight, may be determined by the user, and the determined second flight may be set as a determined flight (S260).

After the second flight is determined in this manner, when there is a remaining segment, the heuristic flight inquiry system 100 may automatically inquire about and select a flight corresponding to the remaining segment or have a flight selected from the terminal 200 in the same manner.

When the user determines the second flight, the application fare rule (the second application fare rule), in which the previously-determined flight is considered, overall fare information, and flight-specific base fare may be provided to the terminal 200. This example will be described later.

Hereinafter, embodiments of a method of providing the heuristic flight inquiry system to which the above-described spirit of the present invention is applied will be described with reference to FIG. 7 to FIG. 17.

When a route map is specified by the user or the routing module 130 as described above, the routing module 130 may provide information about the specified route map 50 to the terminal 200. Information about the route map 50 is provided to the terminal 200, depicted on the map as illustrated in FIG. 7, such that the user can intuitively examine information about route of routing corresponding to the route map, segments, leg, and cities.

In addition, the control module 110 may further provide the estimated fare information 30, the fare rules 40, and/or the determination status information 60 to the terminal 200.

The user may examine pieces of information as illustrated in FIG. 7, and may select a first selection segment (e.g. TPE-AMS). In this regard, the spirit as described with reference to FIG. 8a and FIG. 8b may be applied. Alternatively, the first selection segment (e.g. TPE-AMS) may be selected by the user selecting a segment depicted on the route map 50.

In other words, the control module 110 may recommend a segment, a flight for which is to be determined preferentially, to the user, or a single segment or continuous single segments (e.g. married segments) included in the route map 50 by the user as an discretion may be selected as the first selection segment. In addition, as described above, the selection UI 66 may be used.

In some implementations, as illustrated in FIG. 8c, the control module 110 may further provide information about a second destination city 70-1, e.g. LON, or a second departure city 70-2, e.g. CJU, in addition to information of the destination city or the departure city included in the condition information input from the terminal 200. Although FIG. 8c illustrates an example in which the heuristic flight inquiry system 100 provides the route map 50, including information about the second destination city 70-1, e.g. LON, and/or the second departure city 70-2, e.g. CJU, to the terminal 200, such information may be provided separately from the route map 50.

The second destination city 70-1, e.g. LON, and/or the second departure city 70-2, e.g. CJU, may be at least one destination city, at which the user can arrive by referring to the selected routing, in addition to the destination city, and/or at least one departure city, from which the user may depart by referring to the routing, in addition to the departure city.

When the second destination city 70-1, e.g. LON, and/or the second departure city 70-2, e.g. CJU, are provided to the terminal 200, the same routing is used, such that a variety of journeys can be designed at similar fares. Therefore, the spirit of the present invention is not intended to simply provide information about flights consistent with the original plan of the journey. The spirit of the present invention is very useful for the user to actively design more various journeys having better conditions while inquiring about and/or reserving flights.

For example, as illustrated in FIG. 7, the application fare rules 41 currently applied to the specific routing allow inbound or outbound open jaw tickets. Thus, although the user originally planned his or her journey to travel from Seoul to Rome, Rome (or London) may be set as the destination city in the outbound journey and the user may depart from the second destination city 70-1, e.g. LON (or Rome, the original destination city), in the inbound journey (i.e. London or Rome may be a departure city in in the inbound journey). The plan may be changed without causing significant differences in the fares, based on information about the second destination city 70-1, e.g. LON, and/or the second departure city 70-2, e.g. CJU, provided by the heuristic flight inquiry system 100.

Likewise, it is possible to design a journey to depart from Seoul, the original departure city (or Jeju, the second departure city 70-2, e.g. CJU), and to return to Jeju, the second departure city 70-2, e.g. CJU (or Seoul, the original departure city), without causing significant differences in the fares using the same routing, based on information about the second departure city 70-2, e.g. CJU, provided by the heuristic flight inquiry system 100.

For example, as illustrated in FIG. 8c, when the user selects a position (or an icon) corresponding to the second destination city 70-1, e.g. LON, provided by the heuristic flight inquiry system 100, specific information about the second destination city 70-1, e.g. LON, and/or a heuristic-passible fare as illustrated in FIG. 8c may be provided to the terminal 200 through a UI 80-2.

The user may change the destination city or the departure city to the second destination city 70-1, e.g. LON, or the second departure city 70-2, e.g. CJU, using the terminal 200. The heuristic flight inquiry system 100 may heuristically perform an inquiry about and/or a reservation for the changed destination city or the changed departure city according to the spirit of the present invention.

When the first selection segment (e.g. TPE-AMS) is selected by the user (or is automatically selected by the routing module 130), the control module 110 may provide information about a flight corresponding to the first selection segment (e.g. TPE-AMS) to the terminal 200.

This example is illustrated in FIG. 9.

As illustrated in FIG. 9, the control module 110 may provide the flight information 91 corresponding to the first selection segment (e.g. TPE-AMS) to the terminal 200 through the flight information UI 90.

Information about the first flight may include not only flight information, e.g. 91-1, corresponding to the reference date (e.g. the departure date) of the first selection segment (e.g. TPE-AMS) but also flight information, e.g. 91-2, corresponding to marginal dates as described above. Information about flights illustrated in FIG. 9 may include flight-specific base fares, e.g. 91-1 and 91-2. In the base fares, corresponding flights may only be considered, since there are no previously-determined flights. That is, in the base fares, no flights for other segments may have been considered. Thus, when the first segment (e.g. TPE-AMS) is specified, the control module 110 may inquire about base fares of first flights corresponding to the first segment (e.g. TPE-AMS) from the external system 300 through the fare rule module 140 while providing information about the first flights corresponding to the first segment to the terminal 200, may provide the base fares to the terminal 200, and then may have a first flight selected by the terminal 200. In addition, as illustrated in FIG. 9, the first selection segment (e.g. TPE-AMS) may be depicted on the route map 50 to be distinguishable from the other segments.

The user may select a flight (August 15) corresponding to the lowest base fare 91-2 from among marginal dates. Then, the base fare rule 42 corresponding to the selected flight may be displayed to be distinguishable from the other base fares from among the base fare rules, e.g. 42, 43, and 44, which are being currently provided.

In addition, when the flight (August 15) is selected (i.e. information about the flight is requested to be inquired about), the control module 110 may further provide additional information, e.g. 91-3 and 91-4, to the terminal 200.

The additional information may be a graph, e.g. 91-3, from which the schedule of the selected flight (e.g. August 15) may be intuitively examined. The graph information is an example of a two-dimensional graph on which flight times and local times of available flights are depicted. The particulars of this graph are specifically disclosed in Korean Patent Application No. 10-2013-0110664, “SCHEDULE DISPLAY METHOD AND SYSTEM THEREFOR”, filed by the applicant, and detailed descriptions thereof will be omitted.

In addition, the additional information may be specific information, e.g. 91-4 (such as flight No., flight time, seat class, name of flight) about the flight (e.g. August 15).

The user may select a determination UI, e.g. 91-5, after examining such information. Then, the flight (e.g. August 15) may be set as a determined flight for the first selection segment (e.g. TPE-AMS).

In addition, it is appreciated from FIG. 9 that, when the flight (e.g. August 15) is selected, tax/fee information included in the estimated fare information 30 is changed from the value illustrated in FIG. 7. This indicates that the lowest tax/fee of the flight for the first selection segment (e.g. TPE-AMS) is 535,500 Korean Won, while the lowest tax/fee is 515,500 Korean Won. Thus, the user may examine whether or not values included in the estimated fare information 30 are changed by selecting pieces of provided information about flights, respectively.

In addition, as described above, the control module 110 may further provide the terminal 200 with information about related flights corresponding to the related segments of the first selection segment (e.g. TPE-AMS). This example is illustrated in FIG. 10.

As illustrated in FIG. 10, information, e.g. 92, 93, and 94, about the related flights, i.e. the flights corresponding to the related segments of the first selection segment (e.g. TPE-AMS), may be displayed on the terminal 200. Information about the related flights may include not only information about flights on the reference date but also information about flights on marginal dates.

In addition, the control module 110 may further provide a UI 51 allowing the user to selectively display information about the route map 50.

Through the above-described process, the user may determine the first flight. For example, the user may determine the flight (e.g. dated August 15, with a base fare of 250,000 Korean Won) illustrated in FIG. 9 as the first flight.

Then, the control module 110 may set the determined flight (e.g. August 15) as a determined flight.

In addition, selection segments may be determined from the remaining segments, and flights to be used for the determined selection segments may be determined.

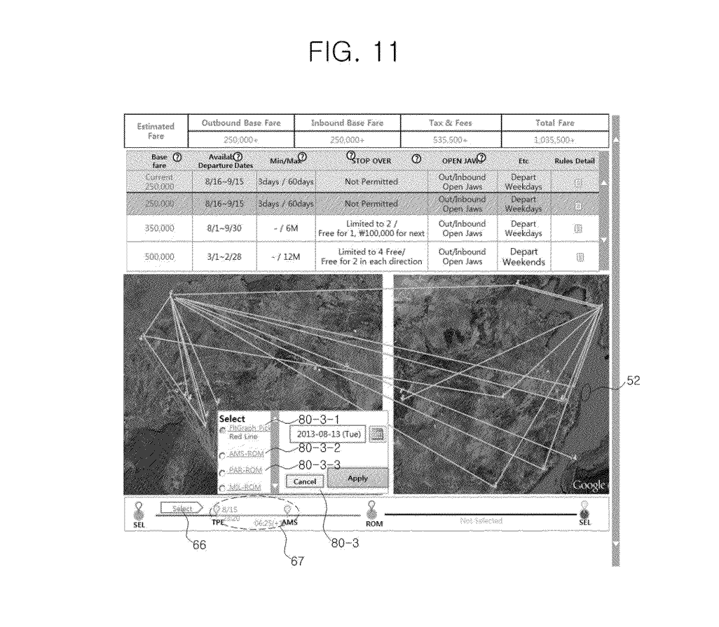

This example is illustrated in FIG. 11.

As illustrated in FIG. 11, a determined segment may be displayed on the route map 50 to be distinguishable from the other segments. Afterwards, the user may specify a second selection segment, i.e. a selection segment from among the other segments for which a flight is to be determined.

In this regard, the user may select a city, e.g. 73, on the route map 50 in the same manner as illustrated in FIG. 8a. Then, as illustrated in the drawings, a UI, e.g. 80-3, through which a second selection segment is to be selected with respect to the city, e.g. 73, may be provided to the terminal 200 by the control module 110.

The UI 80-3 may include a UI 80-3-1, through which a recommended segment is to be selected, and UIs 80-3-2 and 80-3-3, through which discretionally-selected segments including the city 73 as a departure city or a destination city are to be selected. The segment recommended by the control module 110 may be a red line 52, i.e. ICN-TPE, as illustrated in FIG. 11.

In addition, as described above, a second selection segment may be selected through the selection UI 66 included in the determination status information 60. In addition, information 67 indicating the status of the previously-determined flight may be displayed on the determination status information 60.

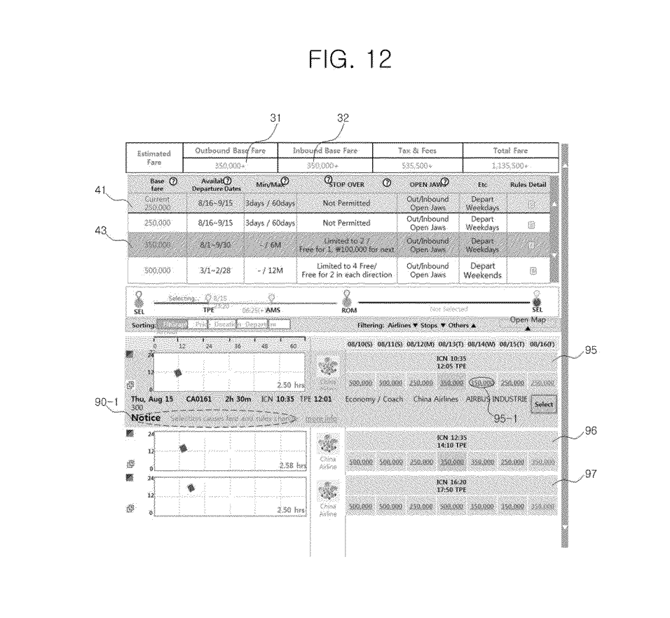

When the second selection segment is determined to be ICN-TPE, flight information, e.g. 95, 96, and 97, about second flights corresponding to the second selection segment as illustrated in FIG. 12 may be provided to and displayed on the terminal 200.

The base fares of flights included in information about the second flights may be base fares at which previously-determined flights are considered or base fares at which previously-determined flights are not considered. That is, information about the second flights may include base fares at which both previously-determined flights and second flights are considered. In some implementations, as illustrated in FIG. 11, information about second flights may include a base fare, e.g. 95-1, at which only second flights are considered. In this case, the user may be able to see whether or not the application fare rule is changed due to the selection of a second flight and/or which base fare rule is applied. Thus, the user may be able to see which effect the selection of the second flight has on the overall fare of the target flight or whether or not the currently-applied fare rule is still available according to selection of the second flight.

In some implementations, both base fares at which previously-determined flights are considered and base fares at which only the second flights are considered may be provided while the base fares of the second flights are provided.

In any case, the user may determine a flight in a step-by-step manner based on fare information at which flights that he or she has selected to the present time. The user may select the second flights by referring to the above-described pieces of information, such as the estimated fare information 30, the fare rules 40, and the route map 50.

When one of the pieces of information about the second flights provided by the control module 110 is determined to be information of a flight for the second selection segment by the terminal 200, the determined second flight may also be included in the determined flights.

In this regard, the user may select the second flights, e.g. 95-1, provided by the control module 110. In response to the selection, the control module 110 may provide the terminal 200 with a base fare rule, e.g. 43, which will be applied when each of the second flights, e.g. 95-1, is selected or a change, e.g. 31 and 32, in the estimated fare information 30. That is, the outbound base fare 31 and/or the overall fare information in the selection of a second flight, e.g. 95-1, may be changed. In addition, since an inbound stopover has to be allowable, the inbound base fare 32 may be changed to a base fare corresponding to the lowest base fare rule in which a stopover is allowable.

When the user selects a second flight, e.g. 95-1, the base fare rule 43 applicable during the determination of the second flight, e.g. 95-1, may be displayed to be distinguishable from the other base fare rules, as illustrated in FIG. 12. When the second flight, e.g. 95-1, is ultimately determined as a flight for the second selection segment, application fare rules, i.e. the second application fare rules 41, may be changed to the base fare rule 43.

As described above, the base fare applicable to the second flight may be higher than the base fare of the first application fare rule that is being currently applied. For example, this may be the case in which a flight of August 14, the base fare of which is 350,000 Korean Won, is selected as the second flight, e.g. 95-1. In this case, the second application fare rule may be the base fare rule 43 corresponding to a higher base fare between the base fare (e.g. 250,000 Korean Won) of the first application fare rule and the base fare (e.g. 350,000 Korean Won) of the second flight.

In addition, in the case in which the user selects the second flight, e.g. 95-1, when the application fare rule that has been applied before the selection is changed, the control module 110 may provide the terminal 200 with notice information 90-1, as illustrated in FIG. 12. Based on such notice information, the user may examine a change in the base fare (i.e. a change from 250,000 Korean Won to 350,000 Korean Won). When the application fare rule is changed as described above, the control module 110 may provide the terminal 200 with the notice information, e.g. 90-1, indicating that the application fare rule is changed. Thus, the user may be allowed to select whether or not to determine the second flight, e.g. 95-1, as a determined flight by changing the application fare rule (i.e. the base fare).

When the notice information, e.g. 90-1, is provided, the user may determine the selected second flight, e.g. 95-1, as the determined flight or may select a new second flight. In some cases, the user may cancel the first flight, which was previously determined flight, while maintaining the second flight.

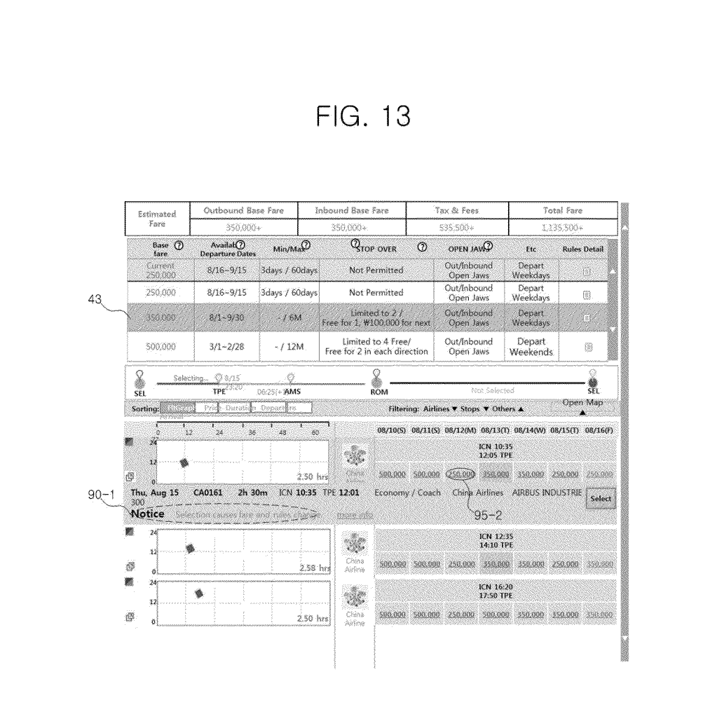

FIG. 13 illustrates an example in which the user selects the second flight (e.g. August 12).

As illustrated in FIG. 13, when the user selects the second flight of August 12, the base fare of the first determined flight is 250,000 Korean Won, and the base fare when the second flight, e.g. 95-2, is selected (e.g. the base fare for which only the second flight is considered) may also be 250,000 Korean Won. However, in this case, a stopover is happened. Since the first determined flight is the TPE-AMS flight of August 13, a stopover is added when the second flight, e.g. 95-2, is selected. This may be the case in which the application fare rule that has been applied, i.e. the first application fare rule, is no longer usable (applicable) due to the first determined flight and the selection of the second flight, e.g. 95-2. Due to the selection of the second flight, the journeys of the first determined flight and the second flight no longer satisfy the first application fare rule. Thus, when the second flight, e.g. 95-2, is selected, the second application fare rule to be applied may be the second base fare rule 43, even if both flights have the same base fare of 250,000 Korean Won. The second base fare rule 43 may be a base fare rule having the lowest base fare while satisfying the journeys of the first determined flight and the second flight.

In addition, at this time, the base fare is changed as described above. The notice information 90-1 as described above may be provided to the terminal 200. The outbound base fare and the inbound base fare included in the estimated fare information may also be changed.

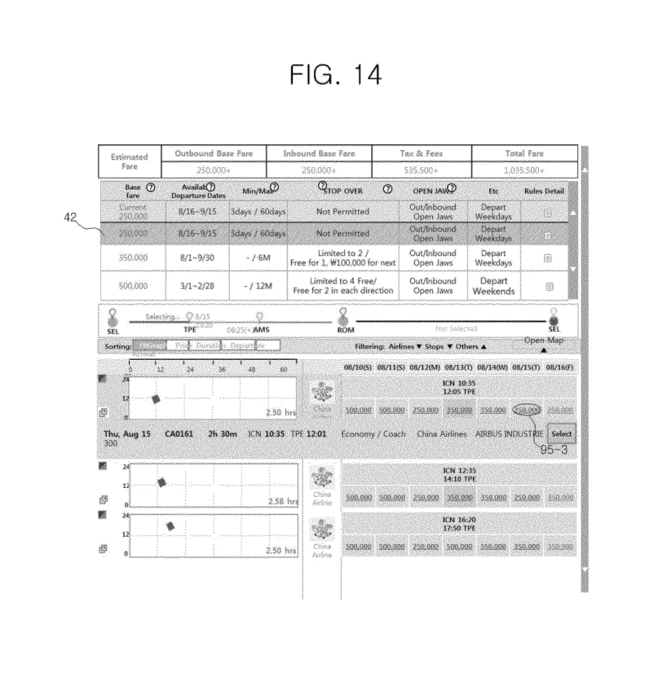

When the user selects the flight of August 15 as the second flight, pieces of information as illustrated in FIG. 14 may be displayed on the user terminal 200.

Referring to FIG. 14, the user may select the flight, e.g. 95-3, of August 15 as the second flight. The base fare of the second flight, e.g. 95-3, may be 250,000 Korean Won, which is the same as that of the first determined flight. In addition, a stopover is not happened. Thus, this may be the case in which the base fare rule to be applied is not changed. In this case, the base fare rule 42 to be applied in the selection of the second flight, e.g. 95-3, may be displayed to be distinguishable from the other base fare rules, as illustrated in FIG. 14.

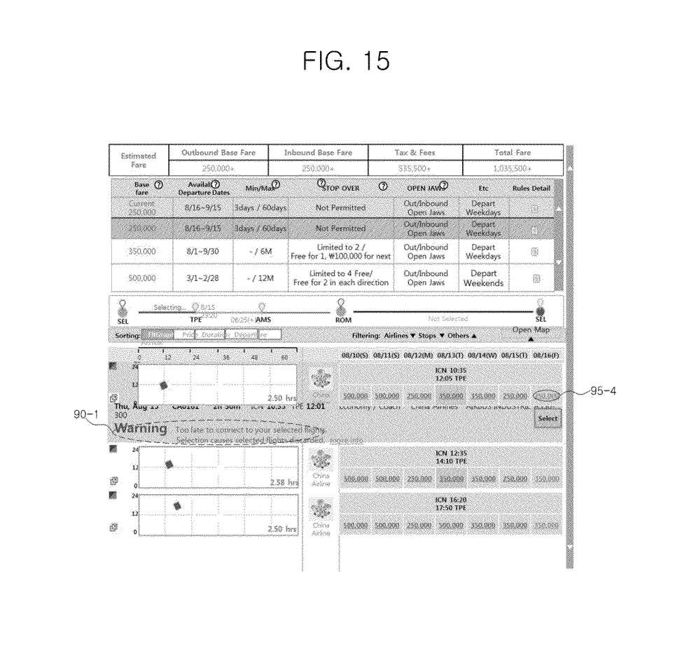

Referring to FIG. 15, the user may select the flight, e.g. 95-4, of August 16 as the second flight. This may be the case in which the second flight arrives at the departure city of the first determined flight later than the departure time (e.g. August 15) of the first determined flight that was previously determined. In this case, the second flight is inconsistent with the first determined flight.

In this case, the control module 110 may provide the terminal 200 with the notice information 90-1 as illustrated in FIG. 15. The notice information 90-1 may be information indicating that the previously-determined flight, which is inconsistent with the second flight 95-4, may be canceled when the second flight 95-4 is selected. Thus, when the user ultimately selects the second flight 95-4, the control module 110 may cancel the previously-determined flight, which is inconsistent with the second flight 95-4. In some implementations, the control module 110 may control the process such that the user does not select the second flight 95-4, which is inconsistent with the previously-determined flight.

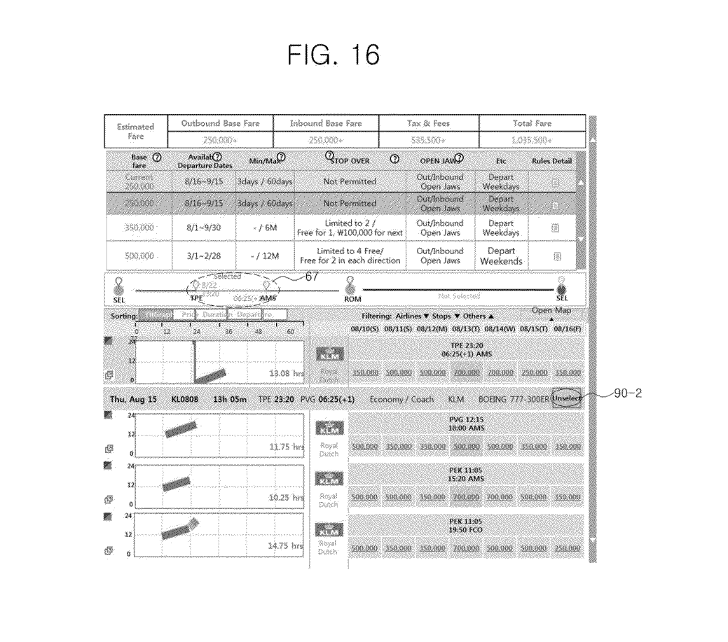

In addition, the control module 110 may cancel the previously-determined flight not only when the flight to be currently selected is inconsistent with the previously-determined flight but also when the user wants. This operation will be described with reference to FIG. 16.

Referring to FIG. 16, the control module 110 may provide the determination status information 60 to the terminal 200 as described above. The determination status information 60 may include the information 67 indicating the status of the determined flight.

When the user selects the information 67 indicating the status of the determined flight, the control module 110 may provide the terminal 200 with information about the determined flight (e.g. TPE-AMS of August 15) corresponding to the selected information 67, as illustrated in FIG. 16. In addition, the control module 110 may provide a UI 90-2, through which the determined flight may be canceled.

The user may select the UI 90-2, and the control module 110 may cancel the determined flight from the target flight.

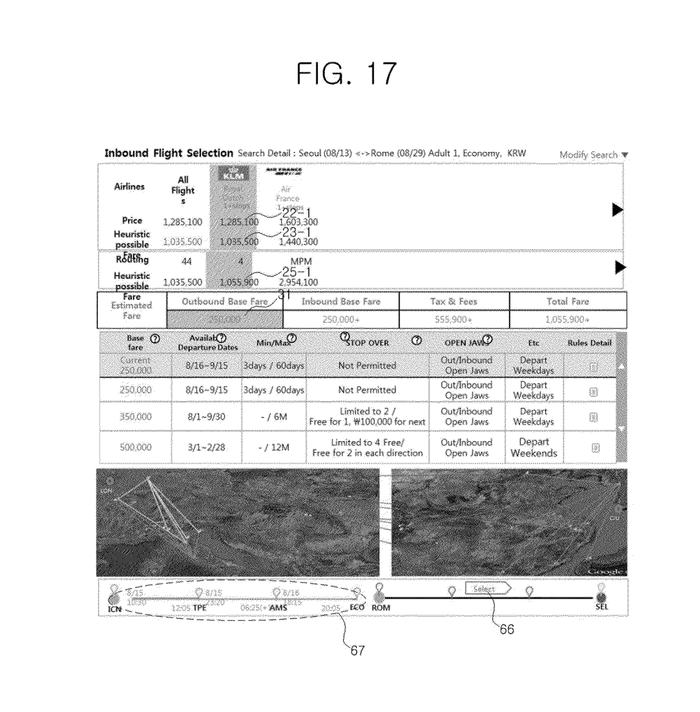

When all the outbound flights are determined in this manner, the control module 110 may provide the terminal 200 with information as illustrated in FIG. 17.

Referring to FIG. 17, fare information, e.g. 22-1, based on which the determined outbound flights are considered, and information about heuristic-possible fares, e.g. 23-1, corresponding to the fare information may be displayed on the terminal 200. In addition, information about routing-specific heuristic-possible fares, e.g. 25-1, may be further displayed. As illustrated in FIG. 17, when the inbound flights are being inquired about and/or reserved, the information based on which the determined outbound flights are considered, e.g. information about airlines able to provide inbound flights connected to the outbound flights, and airline-specific fare information, and heuristic-possible fares, may be provided to the terminal 200.

In addition, the previously-determined outbound base fare 31 of the estimated fare information 30 may be displayed to be distinguishable from the other pieces of information of the estimated fare information 30, as illustrated in FIG. 17.

The user may specify the first selection segment for the inbound target flight and determine the flight for the first selection segment using the selection UI 66 as described above with reference to FIG. 8a or FIG. 8b. In addition, the user may specify a second selection segment and determine a flight for the specified second selection segment as described above.

Accordingly, the spirit of the present invention allows the user to heuristically determine a flight for at least one segment when inquiring about and/or reserving a target flight from a departure city to a destination city including a plurality of segments. The results of inquiries about the other flights (e.g. a flight corresponding to a second selection segment) may be more ideal (or may have higher qualities).

In addition, the user is provided with the estimated fare information 30, the fare rules 40, and information about the route map 50 as described above, as well as information about flights corresponding to marginal dates with respect to the reference dates of the segments. Thus, the user may adaptively and actively design a variety of journeys while inquiring about and/or reserving flights compared to the related art in which an airline ticket corresponding to a journey is inquired about after the journey is determined.

The heuristic flight inquiry method according to the embodiment of the present invention can be embodied as computer readable codes stored in a computer readable storage medium. The computer readable storage medium includes all types of storage devices in which data readable by a computer system are stored. Examples of the computer readable storage medium include read only memory (ROM), compact disc read only memory (CD-ROM), a magnetic tape, a hard disk, a floppy disk, an optical data storage device, and the like. In addition, the computer readable storage medium may be in the form of a carrier wave (for example, a means for conveying data through the Internet). Furthermore, the computer readable storage medium may be distributed to computer systems connected by means of networks, in which computer readable codes are stored and executed in a decentralized manner. In addition, functional programs, codes, and code segments for embodying the present invention may be easily inferred by programmers in the field to which the present invention belongs.

While the present disclosure has been described with reference to the certain exemplary embodiments thereof illustrated in the accompanying drawings, it will be understood by those skilled in the art that various modifications and other equivalent embodiments may be made thereto while remaining within the scope of the present invention. Therefore, the true scope of the present disclosure shall be defined by the concept of the appended Claims.

### INDUSTRIAL APPLICABILITY

The present disclosure may be used for the reservation of flights.

1. A heuristic flight inquiry method of selecting a target flight for a market in which a departure city and a target city are paired, the method comprising:
providing, by a heuristic flight inquiry system, a route map of an airline corresponding to the market to a terminal of a user, wherein the route map is a set of routes from the destination city to the target city allowable by fares and rules of the airline, one of the routes comprising one or more segments;
providing, by the heuristic flight inquiry system, information about first flights corresponding to a first selection segment based on the route map to the terminal, wherein the first selection segment comprises a single segment or a set of a plurality of connected single segments;
having, by the heuristic flight inquiry system, one of the first flights selected as a first selected flight for the first selection segment based on the information about the first flights; and
determining, by the heuristic flight inquiry system, the first selected flight as a first determined flight of the target flight and determining a flight corresponding to a remaining segment of the first selection segment of the target flight.

2. The heuristic flight inquiry method according to claim 1, wherein the step of providing the information about the first flights corresponding to the first selection segment to the terminal comprises further providing information about related flights corresponding to related segments of the first selection segment to the terminal, wherein the related segments are defined as segments including the departure city or the destination city of the first selection segment or segments included in the route map and predetermined to correspond to the first selection segment by the heuristic flight inquiry system.

3. The heuristic flight inquiry method according to claim 1, wherein the step of providing the information about the first flights corresponding to the first selection segment to the terminal comprises:
having, by the heuristic flight inquiry system, the first selection segment selected from the terminal; and
providing information about the flights corresponding to the selected first selection segment to the terminal.

4. The heuristic flight inquiry method according to claim 1,
wherein the step of providing the information about the first flights corresponding to the first selection segment to the terminal comprises:
determining, by the heuristic flight inquiry system, a recommended segment by predetermined way and determining the determined recommended segment as the first selection segment; and
providing information about the recommended segment to the terminal and having the recommended segment selected as the first selection segment from the terminal.

5. The heuristic flight inquiry method according to claim 1, wherein the step of providing the information about the first flights corresponding to the first selection segment to the terminal further comprises, when a segment of married segments operated by the airline information is included in the first selection segment, providing information about flights corresponding to the married segments to the terminal.

6. The heuristic flight inquiry method according to claim 1, wherein the step of providing the information about the first flights corresponding to the first selection segment to the terminal comprises providing the terminal with information about base fares of reservable booking classes of first flights that depart within predetermined marginal dates with respect to a reference departure date of the first selection segment.

7. The heuristic flight inquiry method according to claim 1, wherein the step of having, by the heuristic flight inquiry system, one of the first flights selected as the first selected flight for the first selection segment based on the information about the first flights comprises:
in response to an inquiry request for the first selected flight, judging, by the heuristic flight inquiry system, a first application fare rule including a base fare and a rule to be applied to the target flight according to selection of the first selected flight;
displaying the judged first application fare rule on the terminal; and
having the first selected flight selected from the terminal based on the displayed first application fare rule.

8. The heuristic flight inquiry method according to claim 1, wherein the step of having, by the heuristic flight inquiry system, one of the first flights selected as the first selected flight for the first selection segment based on the information about the first flights comprises:
in response to an inquiry request for the first selected flight, judging, by the heuristic flight inquiry system, overall fare information corresponding to the target flight of a case in which the first selected flight is determined as a determined flight;
displaying the judged overall fare information on the terminal; and
having the first selected flight selected from the terminal based on the displayed overall fare information.

9. The heuristic flight inquiry method according to claim 1, wherein the step of determining the flight corresponding to the remaining segment of the first selection segment of the target flight comprises:
providing, by the heuristic flight inquiry system, information about second flights corresponding to a second selection segment of the remaining segment to the terminal;
having, by the heuristic flight inquiry system, one of the second flights selected as a second selected flight for the second selection segment based on the information about the second flights; and
determining, by the heuristic flight inquiry system, the second selected flight as a second determined flight of the target flight.

10. The heuristic flight inquiry method according to claim 9, wherein the step of having, by the heuristic flight inquiry system, one of the second flights selected as the second selected flight for the second selection segment based on the information about the second flights comprises:
in response to an inquiry request for the second selected flight, judging, by the heuristic flight inquiry system, a second application fare rule including a base fare and a rule to be applied to the target flight according to selection of the second selected flight;
displaying the judged second application fare rule on the terminal; and
having the second selected flight selected based on the displayed second application fare rule,
wherein the second application fare rule is the base fare and the rule supposed to be applied when the first determined flight and the second selected flight are included in the target flight.

11. The heuristic flight inquiry method according to claim 10, wherein the step of judging, by the heuristic flight inquiry system, the second application fare rule including the base fare and the rule to be applied to a selected route according to selection of the second selected flight comprises: comparing a base fare corresponding to the first application fare rule with a base fare corresponding to the second selected flight; and judging a fare rule corresponding to a higher base fare to be the second application fare rule.

12. The heuristic flight inquiry method according to claim 10, wherein the step of judging, by the heuristic flight inquiry system, the second application fare rule including the base fare and the rule to be applied to the target flight according to selection of the second selected flight comprises:
judging, by the heuristic flight inquiry system, whether or not a first journey of the first selected flight and a second journey of the second selected flight are consistent with the first application fare rule that is being currently applied; and
when the first journey and the second journey are judged to be inconsistent with the first application fare rule, judging a fare rule corresponding to a lowest base fare of fare rules consistent with the first journey and the second journey to be the second application fare rule.

13. The heuristic flight inquiry method according to claim 9, further comprising:
receiving, by the heuristic flight inquiry system, a determination cancellation request for at least one of the first determined flight and the second determined flight; and
in response to the received determination cancellation request, excluding at least one of the first determined flight and the second determined flight from determined flights of the target flight.

14. The heuristic flight inquiry method according to claim 9, further comprising, when the second selected flight is inconsistent with the first determined flight or at least a predetermined period of time is situated between the second selected flight and the first determined flight, providing pertinent notice information to the terminal.

15. The heuristic flight inquiry method according to claim 9, further comprising:
receiving a cancellation request for cancellation of the first determined flight from the terminal according to selection of the second selected flight; and
in response to the received cancellation request, determining the second selected flight as the second determined flight of the target flight and excluding the first determined flight from determined flights of the target flight.

16. The heuristic flight inquiry method according to claim 9, wherein the step of having, by the heuristic flight inquiry system, one of the second flights selected as the second selected flight for the second selection segment based on the information about the second flights comprises:
in response to an inquiry request for the second selected flight, judging, by the heuristic flight inquiry system, overall fare information corresponding to the target flight of a case in which the second selected flight is determined as the determined flight;
displaying the judged overall fare information on the terminal; and
having the second selected flight selected from the terminal based on the displayed overall fare information,
wherein the overall fare information is determined based on the second selected flight and flights previously determined when the second selected flight is requested to be inquired about.

17. The heuristic flight inquiry method according to claim 1, further comprising providing, by the heuristic flight inquiry system, determination status information to the terminal, the determination status information including information about previously-determined segments on routes from the departure city to the destination city.

18-20. (canceled)

21. A heuristic flight inquiry method of selecting a target flight for a market in which a departure city and a target city are paired, the method comprising:
providing, by a heuristic flight inquiry system, a route map of an airline corresponding to the market to a terminal of a user, wherein the route map is a set of routes from the destination city to the target city allowable by fares and rules of the airline, one of the routes comprising one or more segments; and
having, by the heuristic flight inquiry system, a flight selected from the terminal, the selected flight corresponding to a segment to be included in the target flight based on the route map,
wherein the step of having, by the heuristic flight inquiry system, the flight selected from the terminal comprises:
when the flight is selected, providing, by the heuristic flight inquiry system, the terminal with an application fare rule including a base fare and a rule to be applied to the target flight and overall fare information to be applied to the target flight according to selection of the flight; and
having the flight selected from the terminal based on the application fare rule and the overall fare information.

22. A computer readable storage medium in which a program for executing the method claimed in claim 21 is recorded.

23-35. (canceled)

36. A heuristic flight inquiry system for selecting a target flight for a market in which a departure city and a target city are paired, the system comprising:
a routing module providing a route map of an airline corresponding to the market to a terminal of a user, wherein the route map is a set of routes from the destination city to the target city allowable by fares and rules of the airline, one of the routes comprising one or more segments;
a control module having a flight selected from the terminal, the selected flight corresponding to a segment to be included in the target flight based on the route map; and
a fare rule module,
wherein, when the flight is selected, the control module provides the terminal with an application fare rule including a base fare and a rule to be applied to the target flight and overall fare information to be applied to the target flight according to selection of the flight, and has the flight selected from the terminal based on the application fare rule and the overall fare information provided thereto
